(19) United States
(12) Patent Application Publication
(10) Pub. No.: US 2003/0069836 A1
(43) Pub. Date: Apr. 10, 2003

(54) Method and apparatus for amending financial transactions

(76) Inventors: Neill Penney, Surrey (GB); David Wright, New Rochelle, NY (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/237,980

(22) Filed: Sep. 10, 2002

Related U.S. Application Data
(60) Provisional application No. 60/318,577, filed on Sep. 11, 2001.
(60) Provisional application No. 60/330,798, filed on Oct. 31, 2001.
(60) Provisional application No. 60/352,512, filed on Jan. 31, 2002.

(51) Int. Cl. G06F 17/60

(52) U.S. Cl. 705/37

(57) ABSTRACT

Method and apparatus for amending financial transactions. The invention allows customers to submit and providers to automatically receive and respond to financial transaction amendment requests over an interconnected data communications network, such as the Internet, using standard Web browsers. The invention automatically provides real-time, context-sensitive transaction status messages and notifications as the amendment negotiations take place. An optional transaction status database records transaction events in real-time and provides transaction archiving and auditing capabilities superior to conventional manual transaction systems.

### RELATED APPLICATIONS

This application is related to and claims priority under 35 U.S.C. §119 to provisional application No. 60/318,577, filed on Sep. 11, 2001, provisional application No. 60/330,798, filed on Oct. 31, 2001, and provisional application No. 60/352,512, filed on Jan. 31, 2002, all of which are incorporated into this application in their entirety by this reference. This application is also related to a co-pending application entitled, METHOD AND APPARATUS FOR CONDUCTING FINANCIAL TRANSACTIONS, application No. ______, filed on even date herewith and assigned to the assignee of the present application, and the entirety of that application is also incorporated herein by this reference.

### BACKGROUND OF THE INVENTION

1. Field of Art

The present invention relates generally to financial transaction systems and, more specifically, to financial transaction systems where at least a portion of the transaction is conducted over an interconnected data communications network, such as the Internet.

2. Related Art

In today's global market, money flows freely between investors and borrowers, and buyers and sellers, across international borders. Money markets, for example, allow market participants to borrow and lend money. In a money market transaction, one counterparty—the borrower—borrows money from the other counterparty—the lender—at a specified rate for a specified period of time. Money market instruments include coupon bearing instruments, such as certificates of deposit (CDs) and repurchase agreements, discount instruments, such as treasury bills, (T-bills) and commercial paper, and derivatives, such as forward rate agreements, interest rate futures and interest rate options.

In another example, foreign exchange (“FX”) markets allow market participants to exchange one currency for another. In an FX transaction, one counterparty buys a specified currency from the other counterparty in exchange for another currency. FX market instruments include spot, forward and swap agreements (defined below).

As investments, most money market and FX instruments are “liquid,” meaning that they can be bought and sold rapidly. This liquidity is the reason many corporate treasurers use these markets to lend or sell spare cash to banks as a way of temporarily “parking” the spare cash in a short-term low-risk investment vehicle before making a financial decision. The banks use the spare cash to make loans to borrowers who need short-term financing. These borrowers may include, for example, other banks, corporations, governments and supranational organizations, such as the World Bank.

For many years, liquidity providers and their customers (the buyers, sellers, lenders and borrowers who do business with liquidity providers) would negotiate, execute and confirm transactions, which are often called “deals,” from start to finish using only manual systems, either by meeting in person (such as at a stock or commodity exchange) or by using telephones and fax machines. But as the markets have grown, and as trading and dealing activities have expanded to cover 24 hours per day, the manual systems have been found to be too slow and inefficient to keep up with market requirements.

Automated online transaction systems for customers and liquidity providers have been introduced in an attempt to address some of these problems. But such systems have so far failed to solve many of the most troubling aspects of the older manual systems. For example, that conventional online transaction systems do not provide a way for customers to submit or providers to respond to requests to change or amend previously submitted deals, except by resorting to the older manual systems, e.g., telephones and fax machines.

Another problem with conventional online transaction systems is that, like the manual systems, conventional online transaction systems typically do not provide customers with real-time, context-sensitive feedback on the status of proposed transactions. Nor do these systems provide users with the tools they need, such as transaction sorters and display filters, to streamline their workflows and organize their displays according to preference. It has been found

Accordingly, there is need for an automated online transaction system that allows customers to submit changes and amendments to previously submitted transactions without having to resort to using manual systems and for providers to respond to such requests automatically. The present invention addresses these problems with conventional online transaction systems, as well as numerous other long-felt but so far unfulfilled needs.

### SUMMARY OF THE INVENTION

In general, the present invention comprises a computer-implemented method for conducting a transaction. The method comprises the steps of: (1) receiving from a customer an amendment for the transaction; (2) sending the amendment to the provider; (3) receiving from the provider a confirmation for the transaction, the transaction including the amendment; and (4) sending the confirmation to the customer. The amendment may comprise a request to change a value date or execution rate for the transaction, a request to use a specified account to execute the transaction, a request to rebook the transaction at an average rate, or a request to apply the rate of a previous transaction to the current transaction. The amendment may also comprise a request to cancel or rebook the transaction or a request to apply a historical rate rollover to the transaction. The amendment may also comprise a combination of two or more of such requests.

Notably, the transaction itself, as opposed to the amendment, may or may not have been submitted using one or more manual methods for conducting financial transactions, such as by fax or telephone, for example. The method may further comprise receiving, prior to receiving the amendment from the customer, an indication from the customer that the amendment will be provided. Furthermore, the indication may comprise the use of a designated account when the transaction was proposed or executed. In other words, the customer signals to the provider that an amendment will follow simply by specifying that the transaction will be targeted to or charged against a particular account. The method may further include the step of receiving from the provider a transaction term, such as a price quote, which is responsive to the amendment, and receiving from the customer an offer to deal that is responsive to the transaction term. Further still, the method may also include receiving a deal completion signal, such as an acceptance or rejection of the proposed amendment, responsive to the offer to deal.

In another aspect, the invention provides a two-phased computer-implemented method for conducting a transaction. The first phase of operation comprises establishing a first communications channel with a provider and sending, via the first communications channel, an indication that an amendment to the transaction will be provided during a second phase of operation. The second phase of operation comprises establishing a second communications channel with the provider, sending the amendment to the provider via the second communications channel, and receiving from the provider, via the second communications channel, a confirmation for a revised transaction, which includes the amendment. The first and second phases of operation may or may not occur substantially simultaneously, and the first and second communications channels may or may not be the same. Moreover, the first phase of operation, and therefore the first data communications channel may involve using one or more manual means for conducting financial transactions, such as a telephone or fax transmission. This aspect of the invention may also include the step of receiving from the provider a transaction term responsive to the amendment, such as a price quote, and receiving from the customer an offer to deal responsive to the transaction term.

In yet another aspect, the invention comprises a method of conducting a transaction that includes: (1) during a first phase of operation, displaying a user activated control configured to indicate whether an amendment for the transaction will be provided in a second phase of operation, the control being responsive to an input by a customer, and updating a status field of a transaction database in response to a value of the control; and (2) during the second phase of operation, displaying, in response to the status field of the transaction database, a graphical representation of an amendment ticket, the amendment ticket being configured to accept the amendment from the customer, sending a summary of a revised transaction to a provider, the revised transaction including the amendment, receiving an input from the provider in response to the summary, and updating the status field in the transaction database in response to the input. In this aspect, the input may comprise a transaction term, or an approval or rejection of the revised transaction received from the provider.

In still another aspect, a computer-readable storage medium encoded with a computer-executable program for conducting a transaction is provided. The program includes code configured to execute during a first phase of operation, to display a graphical representation of a trading ticket for the transaction, the trading ticket including a price quote from a provider, and to display a user-activated first control configured to indicate whether a customer has accepted the price quote. This code will also display a user-activated second control configured to indicate whether an amendment for the transaction will be provided in a second phase of operation, and, responsive to an activation of the first control by the customer, to send a notification to a provider indicating that the price quote was accepted. The code will also update a status field of a transaction database in response to the value of the second control.

The program also includes code configured to execute during the second phase of operation, to display, in response to the status field of the transaction database, a graphical representation of an amendment ticket, the amendment ticket being configured to accept the amendment from the customer, to send a summary of a revised transaction to the provider, the summary including the amendment, to receive an input from the provider in response to the summary, and to update the status field in the transaction database in response to the input. Here again, the input may be, among other things, a transaction term for the revised transaction or an approval or rejection of the revised transaction received from the provider. In this aspect the code configured to execute during the second phase of operation may be further configured to receive from the customer an offer to deal responsive to the transaction term, to receive from the provider a deal completion signal responsive to the offer to deal, and to update the status field in the transaction database responsive to the deal completion signal.

And in yet another aspect, a computer system for conducting a transaction is provided, wherein the computer system comprises: (1) a customer client program configured to display a transaction to a customer, responsive to the operation of a server program, and to accept from the customer an amended transaction based on the transaction; and (2) a provider client program configured to display the amended transaction to a provider, also responsive to the operation of the server program, and to accept from the provider an input responsive to the amended transaction. The server program is configured to convey the amended transaction from the customer client program to the provider client program, and to convey the input from the provider client program to the customer client program. Like all of the aspects described above, the amendment in the amended transaction may comprise a change or a request to use or change a value date or execution rate for an original transaction, a request to use or change a specified account to execute the transaction, a request to rebook the transaction at an average rate, or a request to apply the rate of a previous transaction to the current transaction. The amendment may also comprise a request to cancel or rebook a previous transaction, a request to apply a historical rate rollover to the transaction, as well as a combination of two or more of such requests.

The computer system may further include a database configured to maintain an amendment status for the transaction. If such a database is provided, the server program may be configured to modify the amendment status responsive to the receipt of the amended transaction from the customer client program, the receipt of an input from the provider, the receipt of an offer to deal from the customer, the receipt of an acceptance or rejection from the provider responsive to the offer to deal, or all of the above. In a preferred embodiment, the computer system further comprises an authentication component, which determines user permissions and entitlements when they are logged into the system.

### FEATURES AND ADVANTAGES

The present invention allows customers to use a standard Web browser to submit and negotiate the details of financial transactions, or to request several types of amendments to previously executed transactions, all in near real-time over an interconnected data communications systems, such as the Internet. The invention also allows market makers, liquidity providers, dealers and traders to observe deal completion and to receive and negotiate the details of such proposed changes and amendments, and to provide immediate feedback and confirmations to customers, all automatically, and all according to the conventions and practices typically followed in conducting with such transactions. In the foreign exchange market context, for example, market-makers are be able to quote, re-quote, confirm, execute and withdraw prices on spots, forwards, swaps, and single spot portfolios (SSPs) and multi-spot portfolios (MSPs) for previously submitted transactions, without resorting to the old manual systems, such as telephones and fax machines, to do so.

An advantage of the invention is that it can be configured to work over the Internet, or any other data communications network, using standard Hypertext Transfer Protocol (“HTTP”) and HTTP over Secured Socket Layer (“HTTPS”) ports and “streaming” technology. Thus, customers and dealers may use a standard web browser, such as Internet Explorer Version 5.0 or later, to gain secured access to some or all of the above-described features. Moreover, communication between a server component and a client component of the invention may be encrypted to insure the integrity and confidentiality of the transaction data.

Still another advantage of the invention is that it may be configured to interface with a multiple-bank trading platform, such as the one provided by FXall, Inc., of New York, N.Y., through a set of library routines making up an transaction application programming interface (API). The FXall trading platform, however, is only one example of a trading platform with which the invention described herein will work. The invention is designed to be equally applicable to other trading platforms. Thus, the references to FXall's trading platform below are for exemplary purposes, and should not be construed to limit the scope and applicability of this invention.

### BRIEF DESCRIPTION OF THE DRAWINGS

The invention will be better understood with respect to the accompanying drawings, which constitute a part of this specification and include exemplary embodiments of some of the various forms of the invention. In these drawings:

FIG. 1 is a high-level block diagram of an interconnected data communications system configured to operate according to one embodiment of the present invention.

FIG. 2 is a high-level flow diagram illustrating the steps performed by a system configured to amend financial transactions in accordance with an embodiment of the present invention.

FIGS. 3 through 17 show exemplary graphical user interface screens that can be used in embodiments of the present invention to amend financial transactions.

### DETAILED DESCRIPTION OF PREFERRED EMBODIMENTS

Although the detailed description of preferred embodiments provided herein refers primarily to foreign exchange (FX) deals, these references are only meant to illustrate in clearer detail how the invention may be applied in that particular context, not to serve as a limitation on the applicability of the invention in other contexts. Therefore, such references should not be construed to remove from the scope of the present invention other kinds of financial transactions that could benefit from its application, such as fixed income, equities and money market transactions.

I. Definition of Terms

As used in this description, except to the extent that the context indicates otherwise, the following terms may be understood with reference to the definitions provided below.

1. FX Terms

A “foreign exchange” or “FX” transaction (or “deal”) is a contract to exchange one currency for another at an agreed rate on a specified delivery date, also called a “value date.”

A “value date” or “settlement date” is the date on which the exchange of currencies will take place.

The terms “forward deal,” “forward agreement,” forward outright deal” or “FX outright transaction” refers to an agreement to buy one currency on a specified future value date at a rate that is agreed upon today (i.e. buy X units of one currency, or sell Y units of another currency) on any date other than the FX spot date. There is no exchange of funds until the future value date arrives. As a matter of convenience, it is customary in some markets for participants engaged in negotiating and executing these transactions to rely on a set of standard settlement dates. In the foreign exchange market, for example, dealers, traders, buyers and sellers rely on a set of standard “forward settlement dates,” sometimes called “forward tenors,” which occur one week, one month, two months, three months, six months or twelve months after the spot settlement date (which is defined below). These standard forward settlement dates are usually written as: “IM” for one month, “2M” for two months, “3M” for three month, and so on. In practice, market participants will either agree on a “standard” forward settlement date, or agree on a different day.

The terms “FX spot deal,” “spot trade” and “spot agreement” refer to a transaction or agreement to exchange a single foreign currency for another (i.e., to buy X units of one currency, sell Y units of another currency) on the FX spot date.

The “FX spot date” is usually two working days from the date the agreement is made and is the most liquid (i.e. cheapest) date to buy or sell currency on a given trading date.

The term “FX points” refers to the difference at any time between the price for an FX outright and an FX spot.

The term “swap” or “swap agreement” refers to a deal involving the simultaneous purchase and sale, or sale and purchase, of a specified amount of one currency against another for two different value dates. Although a swap is a single transaction with a single counterparty, the transaction has two value dates (or “legs”) when the exchanges of funds occur.

A “spot rate” is a rate (expressed as combination of a bid (buy) price and an offer (sell) price) at which a market maker will buy and sell the base currency against another currency.

The term “All-in rate” typically refers, in the context of outrights, to the overall rate at which the exchange will occur. The all-in rate is calculated by adding the spot rate and the FX points (the price adjustment).

A “single spot portfolio” (SSP) is an FX deal involving one or more legs in a single currency pair on any combination of value dates. The dealt currency should be the same for all legs. SSP price quotes typically have four components: a spot rate, the FX points for each of the non-spot value dates, and the all-in rates for each of the non-spot value dates.

A “multiple spot portfolio” or “multi-spot portfolio” (MSP) is an FX deal involving one or more legs in multiple currency pairs on any combination of value dates. The dealt currency is not the same for all legs.

2. Parties

The term “Provider” is typically a shorthand reference to a “Liquidity Provider.” A “Liquidity Provider” is typically a financial institution, such as a bank, that serves as a market maker in a trading system. Liquidity Providers quote prices in response to requests from “customers.”

The term “bank,” as used herein, is typically used interchangeably with “Provider.”

The term “dealer” or “trader” typically refers to an employee of the bank or Liquidity Provider who monitors the system from the Provider side and responds to Customers' requests for price quotes.

The term “Customer” typically refers to a user of the system who is not a Bank, Provider, dealer or trader. Customers initiate the dealing process by asking one or more Providers for a price on a particular FX instrument, such as a swap, forward or spot transaction. While “customer” is typically essentially interchangeable with “user,” in some cases, depending on the context, a “customer” may also refer to an aggregation of users, as, for example, in a company.

3. Features

The terms “Transaction Amendment Tool” or “Transaction Amendment System” refer to systems configured in accordance with the present invention, which enables Customers to submit and Providers to receive and respond to amendment requests submitted by Customers using an online transaction system. The Transaction Amendment Tool may also be referred to, in some embodiments of the present invention, as a “Operations Center” or “Operations Desk” program, or a “Operations Desk application.”

The term “Provider Pricing Tool,” or PPT, refers to a system configured in accordance with the invention disclosed in co-pending application No. ______, entitled “METHOD AND APPARATUS FOR CONDUCTING FINANCIAL TRANSACTIONS,” which enables Providers to receive and respond in real-time to price and amendment requests submitted by Customers. The PPT may also be referred to, in some embodiments of that invention, as a “Treasury Center” or “Treasury Desk” program, or a “Treasury Desk application.”

The term “Transaction Status Database” refers to one or more database components incorporated in a Transaction Amendment System configured in accordance with the present invention or a Provider Pricing Tool of the invention disclosed in co-pending application No. ______, entitled “METHOD AND APPARATUS FOR CONDUCTING FINANCIAL TRANSACTIONS.” In embodiments of the invention, the Transaction Status Database holds records of pending and completed deals, a history of transactions and amendments made to them.

4. Amendment Types

The term “Post trade allocation(s)” (“PTA”) refers to functionality, typically used by a Customer fund manager that enables a user to allocate the value units of a trade to a plurality of different accounts. Each value date in the trade (e.g. buy $100 m against EUR at 0.8700 $ per EUR on Feb. 10, 2002) is split into multiple exchanges on the same value date and at the same exchange rate. Each exchange is typically for a different fund managed by a different fund manager. For example, the deal above might be split into two transactions: buy $120 m against EUR at 0.8700 $ per EUR on Feb. 10, 2002 for FUND1 and sell $20 m at 0.8700 $ per EUR on Feb. 10, 2002 for FUND2). In an embodiment of the invention, the total value of all the FX transactions allocated across all the funds is usually very close to the original amount traded. However, in an embodiment, the Provider will allow small differences at its discretion.

The term “value date to follow” (“VDTF”) means the value date of a proposed transaction will be provided at a later time. Because of the way the dealing process works, it may be more convenient for the Customer to hold off on identifying the value date for a proposed transaction at execution time. For instance, a customer who proposes to buy an FX outright may inform the Provider at execution time that the value date is to be provided at a later time. Later, the Customer informs the Provider of the desired value date, and the Provider informs the Customer of the change in price arising from changing the value date. Once the Customer agrees to the price change, the amendment is complete.

The term “Rebook at Average Rate” (“RAR”) is used to describe a transaction in which a Customer requests combining into a single large deal, several smaller deals. Before proceeding with the confirmation process, the Customer asks the Provider to rebook the multiple small deals as a single large deal with a new exchange rate. The parties calculate the effective exchange rate the Customer has achieved over all the small deals (i.e., the “average rate”) in order to book the single large deal.

The term “Cancel and Rebook” (“CAR”) is used in situations where the Customer submits an arbitrary request to change or correct a detail on a trade (e.g. because the amount is wrong, the value date is wrong, or the Customer accidentally selected “Buy” instead of “Sell”). If the bank agrees to the change and the Customer has agreed to any price changes arising from the modification in trade details, the parties then adjust their deal records in their trade systems. In an embodiment of the invention, for Cancel and Rebook, the approach is to cancel out the original deal, add a new deal with the modified details into the trade system, and create a “Rebooking Link” that connects the two deals. This helps preserves an audit trail in the trading systems.

The term “Historical-Rate Rollover” (HRR) refers to a foreign exchange transaction in which a Provider extends a forward trade on behalf of his customer. In a typical case, the customer asks the provider to apply the original rate of a maturing contract to a new contract which, effectively, extends the maturing trade.

5. Miscellaneous Concepts

The term “Straight-through-Processing” refers to the end-to-end automation of the trading process from order to settlement. It involves the seamless, automated, electronic transfer of trade information to all parties involved in the trading cycle as early as possible.

The terms “Authentication” and “Entitlements Management” refers to the ability to control which users can carry out which activities in a given computer system.

The term “Quick Trade” refers to a straightforward way to execute a trade on the trading platform offered by FXall, Inc. In a Quick Trade, the Customer opens a deal ticket and enters the currency pair, amount, value date and choice of banks. The Customer then submits the details to a transaction server and prices from the selected Providers appear in the Quick Trade Ticket. To deal, the Customer clicks on the price from one of the Providers.

The term “Direction” of the block (as in “allocations can be in same or opposite direction as block, to support netting”) can be understood with reference to the following example: If the block was a “buy” of EUR and “sell” of USD, an allocation is in the same direction if it is also a buy of EUR and sell of USD and in the reverse direction if it is a sell of EUR and a buy of USD.

The term “uneven swap” refers to a situation where the legs of an FX swap involve different amounts of the dealt currency. By contrast, if both legs of an FX swap involve the same amount of the dealt currency, the swap is said to be even. For example, if a Customer wishes to buy $10 m against GBP (“GBP” being the code conventionally used for British sterling currency) at the near date and sell $10 m against GBP at the far date the swap is even. However, if the Customer wants to buy $10 m against GBP at the near date and sell $11 m against GBP at the far date, the swap is uneven.

The term “Mismatch” is used to describe situations where the sum of transaction allocations do not match total amount of FX as the original deal. In such cases, there is said to be a mismatch in the amounts between the allocations and the original deal.

6. Acronyms

API—Application Programmer Interface. Used colloquially without expansion to denote a computer-to-computer interface.

OMS—Order Management System. An Order Management System is used by a Customer to maintain a record of which FX deals need to be executed in the market, who should execute them, etc. Once a deal is executed, the OMS is updated with the execution rate for each deal.

SSP—Single Spot Portfolio. A foreign exchange transaction or “deal” involving multiple value dates for a single currency pair. The Provider quotes a single spot rate (hence the name) together with FX points for each value date.

MSP—Multiple Spot Portfolio. A foreign exchange transaction or “deal” involving multiple value dates for multiple currency pairs.

Provider Transaction API—Application programming interface used by Provider banks to interact with the PPT Server and, optionally, with each bank's rate engine and pricing software. Through this interface, which resides and executes on the Providers' computers, the PPT Server sends RFQs received from Customers, Providers send back quotes, and Customers accept/reject the Provider's quotes.

RFQ—Request For Quote. A trading protocol whereby the customer initiates the trade by asking for a price on a particular currency pair, value date, and amount. The bank responds by sending a price. In order to accept the price, the Customer sends the Provider an “Offer to Deal.”

PTA—Post Trade Allocation

VDTF—Value Date to Follow

RAR—Rebook at Average Rate

C&R—Cancel and Rebook

JVM—Java Virtual Machine. A software component used to run Java programs.

SSO—Single Sign-On

USD—United States Dollars.

GBP—United Kingdom Sterling

JPY—Japanese Yen

CHF—Swiss Franc

EUR—European Euro

CAD—Canadian Dollars

II. Overview of the Invention

The present invention, which is sometimes referred to as a “Transaction Amendment Tool,” allows a Customer to use a data communications network, such as the Internet, to send a request to amend a previously submitted transaction to a Provider connected to the same data communications network. In one embodiment, the Provider logs onto a Web server over the Internet, downloads a relatively generic pricing tool applet to a local workstation, and uses the applet to connect directly to a provider pricing tool server, which is in turn connected to an amendment tool server. The applet monitors amendments and amendment requests it receives from the amendment tool server via the provider pricing tool server and sends an alert to the Provider when an amendment arrives. The Provider may type or select a response (e.g., a confirmation, an acceptance, a rejection, a price quote, etc.) to the amendment into the applet, which passes the response back to the provider pricing tool server, which in turn passes the response back to the amendment tool server, which passes it to the Customer.

In another embodiment, the Provider uses a custom application program incorporating calls to a set of library routines (collectively referred to as a “Provider Amendment API”), instead of the applet, to communicate with the provider pricing tool server. In other words, the program running on the Provider workstation, and being used by the Provider to receive amendments and provide responses, is an API, preferably written especially for the Provider's system, and not a provider pricing tool applet downloaded from the provider pricing tool server. In this case, the API may also be coupled to a separate rate engine (or rate “feed”), a separate pricing tool, or both.

The Customer may submit the amendments by logging into and using an amendment tool interface, which may be downloaded from an amendment tool server or programmed using a set of library interface routines. The amendment tool interface is configured to accept input from the Customer comprising amendments or offers to deal responsive to the Provider's quotes and to send the amendments or offers to deal to the amendment tool server, which passes them directly to a provider amendment API, or to the provider pricing tool server, which passes them to the provider pricing tool applet, depending on which program the Provider is using. Notably, the Customer is not required to use the amendment tool interface to submit amendments. Instead, the Customer may elect to submit amendments by logging directly into the amendment tool server and typing in proposed amendments, or else by cutting, pasting or importing proposed amendments from other trading applications and platforms. Either way, the proposed amendment details are accepted by the amendment tool server, and handled appropriately.

An amendment may involve, for example, a request to change a value date, a net amount or an account allocation for a previously executed trade, a request to cancel or rebook a previously executed trade, or a request to apply a historical rate rollover to a previously executed trade. Depending on the configuration of the system (for there are numerous optional configurations possible), an amendment request may or may not pass through a transaction server before it is passed to the amendment tool server. The amendment tool server passes the solicitation to the provider pricing tool applet (via the PPT Server) or to the provider amendment API, as the case may be, running on the Provider's workstation. The provider pricing tool server, provider pricing tool applet, transaction server and provider transaction API are also components of an invention claimed in co-pending application Ser. No. ______, entitled “METHOD AND APPARATUS FOR CONDUCTING FINANCIAL TRANSACTIONS,” which was filed on even date herewith, is assigned to the assignee of the present application, and which is incorporated in its entirety into this application by reference. Nevertheless, the transaction amendment tool of the present invention may be configured, as described below, to interface with these components to handle amendments in a comprehensive online transaction and transaction amendment system.

In addition to the provider pricing tool server, the provider pricing tool applet, the provider transaction API, the transaction server, the transaction tool applet, the amendment tool server, the provider amendment API and the amendment tool interface referenced above, the present invention may also include other components, such as one or more transaction status databases, authentication and entitlement systems, indicative rate engines, web page servers, and the like, to provide additional functionality, as described in more detail below.

II. High-Level Architecture Description

A high-level description of the overall architecture for the present invention, followed by a more detailed description of some of its components, is now provided.

As stated above, Customers typically, although not necessarily, download, install and launch an amendment tool interface, which allows them to submit amendments to Providers, and to receive responses from Providers via a PPT Server. For foreign exchange transactions, for example, Customers request changes to value dates, changes to allocations, cancellations and historical rate rollovers.

Providers, on the other hand, in at least one embodiment of the invention, download and launch an applet, hereinafter called “the PPT Applet,” from a PPT Server via a JAVA plug-in. After the PPT Applet is downloaded to a Provider's system, Providers log into the PPT Applet and, via a customizable graphical user interface, use the interface to review and respond to amendment requests submitted by Customers. Providers respond to the amendment requests, for example, with either a quote, re-quote, acceptance, denial, withdraw or abort signal, by entering commands on the PPT Applet running in the Java plug-in. Completed deals are displayed on the Provider's onscreen blotters and recorded in a transaction status database. (The user interface for the PPT Applet, as well as its interaction with the PPT Server are described in detail in co-pending application No. ______, entitled “METHOD AND APPARATUS FOR CONDUCTING FINANCIAL TRANSACTIONS,” which is incorporated in its entirety into this application by reference.). The PPT Applet transmits the Provider's responses to the PPT Server (preferably using HTTP tunneling via the Internet or leased lines), which then sends the responses to the amendment tool server, which sends it to amendment tool interface running on the Customer's machine.

III. Detailed Architecture Description

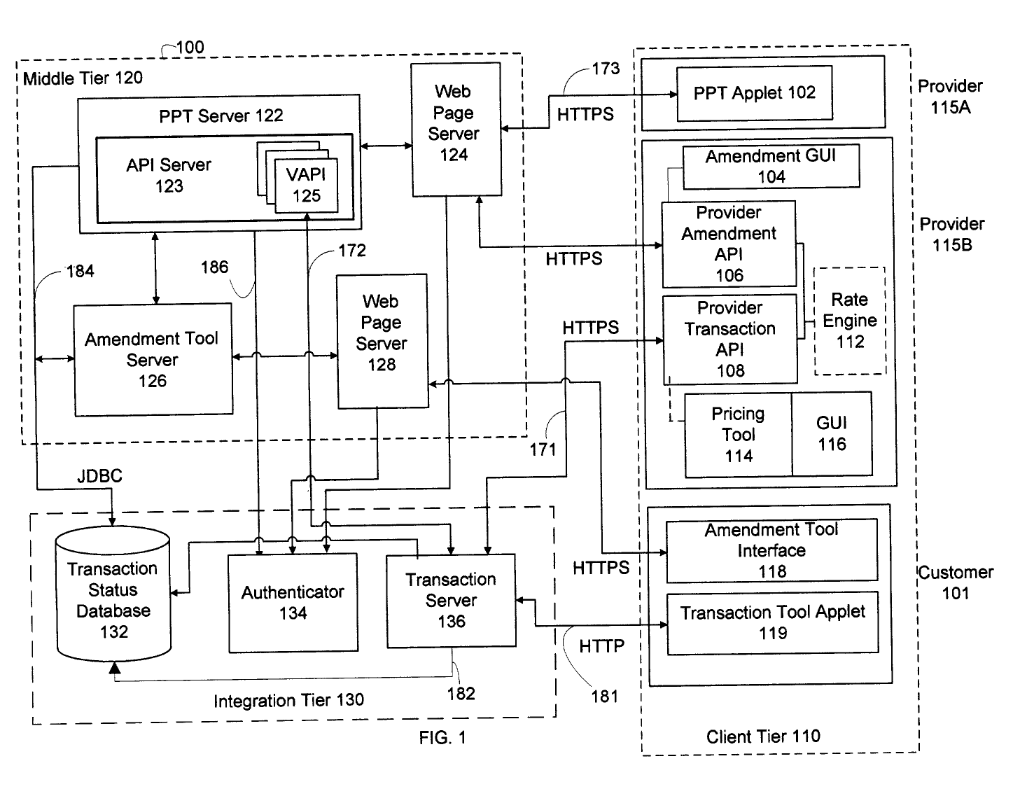

FIG. 1 shows a high-level block diagram of a system configured to operate according to the embodiment of the present invention, as just described above. As shown in FIG. 1, the system 100 comprises a Client Tier 110, which contains the applets and customized application programs Customers and Providers use to communicate with other components of the system, a Middle Tier 120, which contains the servers for the provider pricing tool and the above-referenced amendment tool, and an Integration Tier 130, which provides database, authentication and transaction server functionality.

Using a standard Internet browser, Customer 101 logs into Amendment Tool Server 126 or Transaction Server 136 and downloads Amendment Tool Interface 118 or Transaction Tool Applet 119. Customer 101 may also opt to use his own trading application (not shown in FIG. 1), instead of Amendment Tool Interface 118 or Transaction Tool Applet 119, which may be configured to interface directly with Transaction Server 136 according to a specified protocol. Customer 101 may also decide to type or import proposed transactions, transaction details or amendments directly into Amendment Tool Server 126 or Transaction Server 136 without downloading one of these programs. In any case, Transaction Server 136 receives solicitations from Customer 101 and sends those solicitations directly to a Provider system (if the provider uses a Provider Transaction API), or to API Server 123 at the Provider Pricing Tool Server 122 (if the Provider uses the PPT Applet). Likewise, Amendment Tool Server 126 receives amendment requests from Amendment Tool Interface 118 and sends them directly to a Provider system (via PPT Server 122 and API Server 123).

In a preferred embodiment, Amendment Tool Server 126 is configured to receive amendment requests from Customers using Amendment Tool Interface 118, which it sends to Providers as described below, and responses to amendment requests and confirmations from Providers, which it passes back to the Customers. Amendment Tool Server 126 may also be configured to receive indicative market rates from another source, and provide such rates to the Providers along with any amendment requests that require the Providers to send a quote back to the Customers.

A Provider may download and use PPT Applet 102 to receive and respond to amendments, or, alternatively, may build or write his own solicitation-monitoring program using the set of library routines configured to interact with Amendment Server 126. As shown in FIG. 1, for example, Provider 115A uses PPT Applet 102 to receive and respond to amendments, while Provider 115B uses Provider Amendment API 106 for the same purpose. If the Provider uses an applet, an API Server 123, which is coupled to or resides in PPT Server 122, establishes a “virtual” API client (depicted as VAPI 125 in FIG. 1) for that Provider, which is configured to communicate with Amendment Tool Server 126, as if it were running at the Provider's location instead of on PPT Server 122. From the perspective of Amendment Tool Server 126, however, VAPI 125 acts just like the client Provider Amendment API 106. Thus, Amendment Tool Server 126 can be advantageously programmed to use the same communication protocol to interface with different Providers irrespective of whether the Providers use applets downloaded from PPT Server 122 or their own Provider Amendment APIs.

When Provider 115A connects to the system by launching PPT Applet 102, and Provider 115B connects to the system by launching Provider Amendment API 106, Amendment Tool Server 126 receives signals from API Server 123 indicating that Providers 115A and 115B are both present and accepting amendment requests. If the Amendment Tool Server 126 then receives an amendment request bound for Provider 115B, or learns from checking Transaction Status Database 132 that amendment requests for that Provider are waiting to be processed, it sends the amendment requests to PPT Server 122, which then sends the requests to the Providers, preferably using Hypertext Transfer Protocol over Secure Socket Layer (“HTTPS” or “HTTP over SSL”). (HTTPS is a Web communications protocol that encrypts and decrypts user page requests, as well as the pages that are returned by a Web server in response to the requests).

If the amendment request is a Value Date To Follow, Cancel And Rebook, Rebook At An Average Rate or a Historical-Rate Rollover transaction, which essentially means the customer wants to negotiate a new transaction, then the Provider will need to send the Customer a price quote. To expedite this process, Amendment Server 126 may be configured to receive current rate information (i.e., indicative price quotes) from a separate rate feed or database (not shown in FIG. 1) and send that information to each Provider along with the amendment request. Alternatively, Providers may obtain current rate information from a separate rate engine (shown as Rate Engine 112 in FIG. 1, for example). PPT Applet 102 may be configured to provide users with, among other things, visual and/or audible alerts indicating that a new amendment has arrived, or that a new solicitation has arrived that will need amending later.

Providers who receive requests for amendments to prior transactions may respond to the request with a price quote, as state above, or an acceptance or rejection. In the case of Provider 115B, who has built its own Provider Amendment API 106, the price quote may be obtained from a separate and optional Pricing Tool 114 built or purchased by the Provider. Provider Amendment API 106 may also include an optional customized graphical user interface (shown as Amendment GUI 104 in FIG. 1) designed to accommodate specific dealing or trading requirements of the Provider. Whatever the Provider's response, and from whatever source it is derived, it is subsequently sent back to Amendment Tool Server 136 via API Server 123. Amendment Tool Server 126 then sends the response back to Amendment Tool Interface 118, where the customer can read and respond to it.

As shown in FIG. 1, the system may also include a Transaction Status Database 132 (or multiple transaction status databases), which may be coupled to Amendment Tool Server 126 via link 184 and PPT Server 122 via link 186, and which is configured to record the transaction details of pending and/or completed transactions, as well as a current status for each such transaction (such as whether the transaction is currently locked by a user). In a preferred embodiment, Transaction Status Database 132 is updated in real time each time a transaction status-changing event takes place in the system. In addition, Amendment Tool Server 126 can be configured to communicate with Transaction Status Database 132 using the Java Database Connectivity (JDBC) protocol, which is an application program interface (API) specification for connecting programs written in Java to the data in popular databases. JDBC provides the ability to encode database access request statements in Structured Query Language (SQL) that are then passed to a program that manages the database.

The present invention may also include an authentication and entitlement component (shown in FIG. 1 as Authenticator 134) or multiple authentication and entitlement components (not shown in FIG. 1), which determine whether a user can log on more than once, whether a user can log on at all, and/or what actions the user can perform once logged on. In a preferred embodiment, Authenticator 134 is configured, for instance, to determine user permissions and entitlements based on a “role” to which the user has been assigned. Provider bank employees who have been assigned the roles of “Dealers” or “Traders,” for example, may have access to certain functions, or may be authorized to execute and/or confirm certain transactions that are not the same as the functions and transactions available to employees assigned to other roles, such as “account manager” or “middle office worker.” Authenticator 134 may also be configured to operate in conjunction with a lightweight directory access protocol (LDAP) directory, as is known in the art, which specifies the logical locations within a data communications network where certain individuals, organizations and resources may be found.

Web Page Servers 124 and 128 in FIG. 1 use the client/server model and HTTP, as is known in the art, to send the files that form Web pages to the Provider and Customer client applications (whose computers contain HTTP clients that forward their requests). Every computer on the Internet that contains a Web site must have such a Web server program.

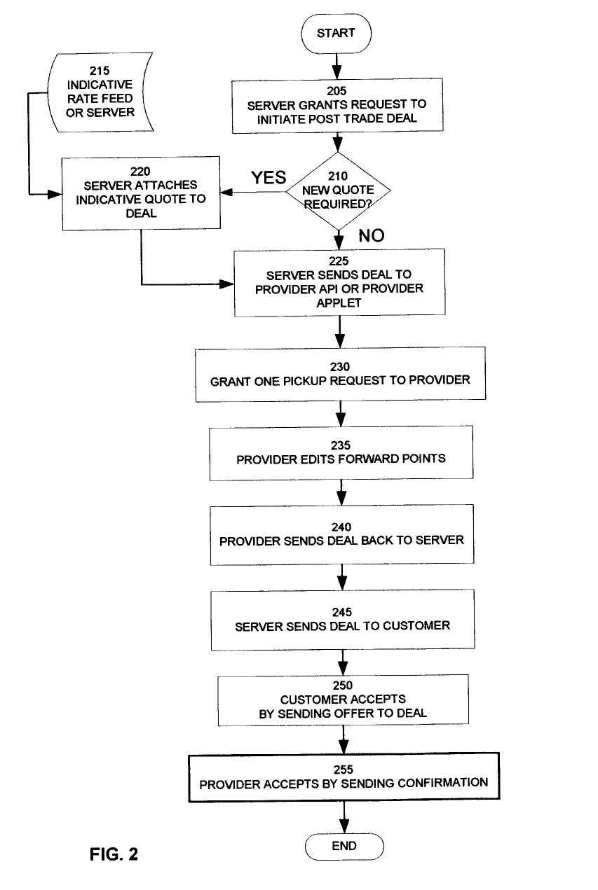

FIG. 2 contains a flow diagram illustrating the data flow in an embodiment of the present invention. As illustrated by step 205, amendments are initiated when the server grants a Customer request to initiate a post-trade deal (PTA, VDTF, RAR, CAR, HRR). The server then determines whether quotes are required, step 210. If the answer is no, processing continues at step 225, wherein the server sends the deal to a Provider. If a deal contains requests for VDTF, RAR, CAR or HRR, quotes from the provider are required, and, as illustrated by step 220 in FIG. 2, the server retrieves indicative quotes from a separate rate feed or server 215, and attaches the quotes to the deal. When a customer requests value dates to follow, for example, the server will supply indicative forward points for each value date for the currency pair specified in the deal. Next, in step 225, the deal is sent to the Provider API or Provider Applet, depending on the program the Provider uses. In a preferred embodiment, the server grants the Provider one pickup request for the deal, step 230, so that only one Provider user can negotiate a deal at one time.

The Provider then edits the forward points for each value date, step 235, and sends the deal back to the server, step 240. The server sends the deal with the edited rates back to the Customer, step 245. If the Customer accepts, as in step 250, an offer to deal is sent from the Customer to the Server and then to the Provider. Finally, in step 255, the Provider accepts the offer to deal by sending a confirmation, and the amendment to the transaction is considered complete—although, obviously, the actual trade and settlement will not be completed until the value date arrives, which could still be a year into the future. In some embodiments, the Provider Applet will automatically confirm or accept an offer to deal if the Customer responds to the price quote within a specified period of time and the dealer has not sent a signal to withdraw the quote, with no action on the part of the human operator at the provider workstation.

Although not shown in FIG. 2, the Amendment Tool Server may be configured to send all unlocked amendment requests currently in a cache or a database for a Provider to the Provider for display in his blotter whenever the Provider logs in. As stated above, amendments are considered complete when the provider client accepts the deal. When the server receives this message, the amended trade is stored in the database and both the customer and provider are notified. Intermediate amendment states may or may not be recorded in the database, depending on the specific application.

A. Implementation Considerations

Embodiments of the present invention may be implemented using: Java 2 SDK, Standard Edition, v 1.3 and Java Plug-in, v 1.3.x, available from Sun Microsystems Corporation of Mountain View, Calif. (www.sun.com); JTIWeb from Random Walk, Inc., of New York, N.Y. (www.randomwalk.com); JRun Server 3.1 Professional Edition, available from Macromedia, Inc. of San Francisco, Calif. (www.macromedia.com); Web Server 4.0, available from IPlanet, a division of Sun Microsystems; Data Server 8.1.7 and JDBC Thin drivers from Oracle Corporation of Redwood Shores, Calif. (www.oracle.com); and Internet Explorer 5.x and 6.0, available from Microsoft Corporation of Redmond, Wash. (www.microsoft.com). However, upon reading this disclosure and practicing the claimed invention, those of skill in the art will recognize and appreciate that some components of embodiments the invention may be implemented equally as well using the products and services of other companies, which have the same or similar features. Therefore, the detailed descriptions herein of specific implementations of the invention are intended merely to illustrate its principles, but not to limit its scope.

B. Amendment Types

For the PTA, VDTF and RAR amendments, the customer indicates at execution time that amendments will be necessary. The provider therefore withholds the deal from the confirmation process until the amendments have been submitted and agreed.

1. Post Trade Allocations

To apply post-trade allocations to a block, the trader submits a list of accounts and amounts to the bank. The total amount allocation usually sums to exactly the block amount, although the bank may accept small deviations.

2. Value Date to Follow

For VDTF amendments, the Customer carries out an FX outright transaction in two stages. The customer initially executes an FX spot deal. This part of the deal may be executed using the online transaction system described herein and as pictured in FIG. 1, or the by some other means, such as by telephone or facsimile. Subsequently, the customer informs the bank of the desired value date and the two agree on the FX points. Potentially, the customer can split the spot trade across multiple accounts and negotiate a different value date for each.

3. Rebook at Average Rate

The Customer executes a number of transactions with the same provider. These are then cancelled and rebooked as a single deal (at the provider-calculated weighted average execution rate). The customer can then go on to apply post-trade allocations or value date amendments to the rebooked deal.

The next two types of amendment are requested when the Customer wishes to amend an existing trade after the trade has been confirmed. The customer is therefore not able to indicate at trade time that amendments will be forthcoming.

4. Cancel and Rebook

The customer submits an arbitrary amendment request to a deal executed on the FXall trading platform. The provider accepts the amendments and potentially the two counter-parties negotiate a new price. The original deal is then cancelled and replaced by the amended deal.

5. Historical-Rate Rollovers

Historical-rate rollovers involve the extension of a forward trade by a provider on behalf of his customer. In a typical case, the customer asks the provider to apply the original rate of a maturing contract to a new contract, which effectively, extends the maturing trade.

C. Amendment Tool Interface Screen Layouts

Amendment Tool Interface 118 allows Customers to conduct post-trade operations. Because it is HTML-based, the client is accessible over the Internet using a standard web browser, with no additional software installation required. In a preferred embodiment, the web pages are dynamically generated by Java Server Pages (JSPs), and take advantage of modem web technologies like Cascading Style Sheets (CSS) and JavaScript to create a customized, professional application.

The Interface has five primary screens, each represented by a tab on a navigation bar, which is visible at the top of every screen:

Working Blotter—The Working Blotter is the primary work screen. It displays to the Customer a table of deals needing amendments, allows the Customer to select the appropriate amendment action in the table, prepare the amendments, submit the amendments to the Provider, and, when necessary, approve the Provider's price quote.

Archive Blotter—The Archive Blotter is the main search interface for completed deals. This blotter allows Customers to search deals according to various details of the deals, such as “Deal ID,” “Currency Pair” and “Trader.”

Import Allocations—The Import Allocations Screen allows Customers to create allocations based on raw data imported from a flat files, to cut and paste allocations from an electronic clipboard, and import allocations from an STP feed.

Manage Allocations—The Manage Allocations screen allows the user to manage free allocations, grouped allocations, and template allocations (defined below).

Administration—The Administration screen allows the Customer to perform certain administrative tasks, such as assigning a break account given a provider. Also allows the customer to indicate which currencies are candidates for truncation rather than rounding.

In a preferred embodiment, the Interface provides buttons, hyperlinks, drop-down menus, editable text fields and keyboard commands are available to the user to help the user initiate or confirm actions, navigate through the system and select various options. After login, the Working Blotter tab is selected by default. Users move to other screens by selecting the appropriate tab. Only one screen may be displayed at a time. However, the user may open additional browser windows and view different screens tab in each browser window. These additional browser windows will not require the user to login again.

1. Allocation Terminology:

Assignable—An allocation is “assignable” to a specific amendment ticket if its currency pair matches the ticket's currency pair, its account is supported by the ticket's provider institution, and the ticket would allow this allocation to be added based on the specific amendment operation's additional rules. For example, an allocation whose value date does not match any current leg on an amendment ticket might be assignable during Value Date To Follow but not Post Trade Allocations. A group or template is assignable to an amendment ticket if all of its allocations are assignable to the ticket.

Correctly Allocated—An amendment ticket is correctly allocated when it has:

1 or more legs;

1 or more allocations per leg;

A unique and non-empty value date, today or after, for each leg

A non-zero “Allocated Amount” for each leg; and

A non-zero “Amount” for each allocation.

2. Working Blotter

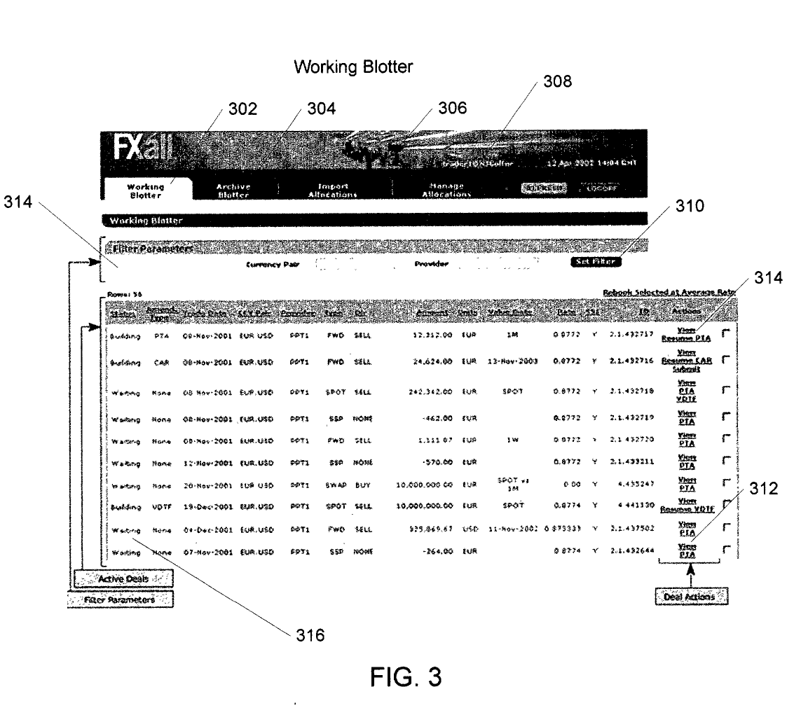

FIG. 3 depicts an example of the Working Blotter, which is the main user interface screen for Amendment Tool Interface 118. As illustrated in FIG. 3, the Working Blotter displays deals requiring amendments. As in all of the screens in Amendment Tool Interface 118, multiple tabs 302, 304, 406 and 308 are displayed on the upper part of the Working Blotter Window. The Customer may switch to another application module by clicking on one of these tabs.

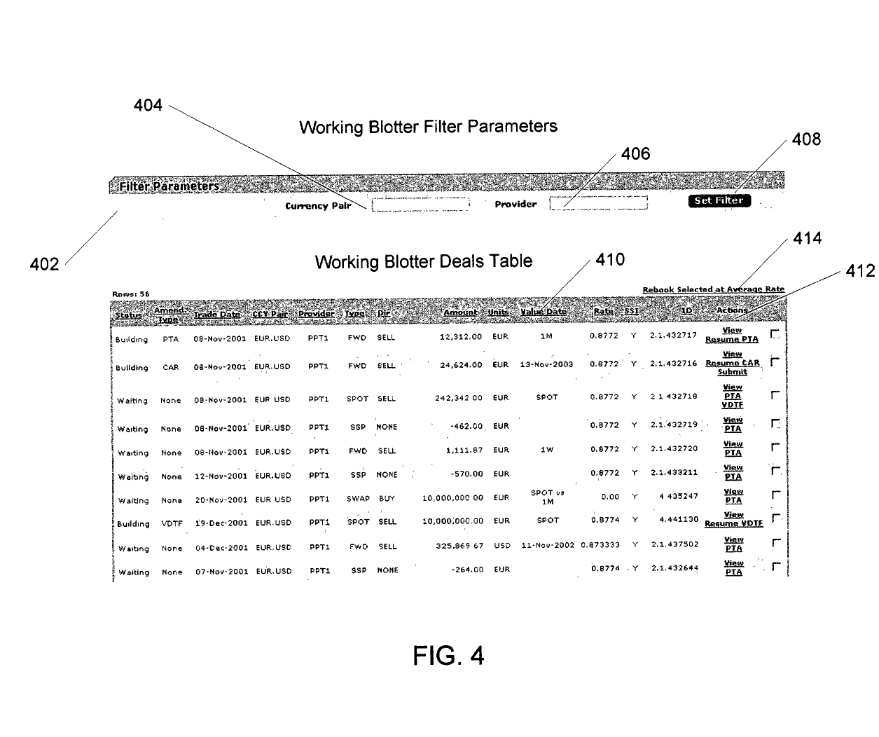

The upper section of the Working Blotter screen (shown as section 314 in FIG. 3 and section 402 in FIG. 4), is used to supply filter parameters. This section provides two fields, Currency Pair 404 and Provider 406, which can be used to narrow down the number of displayed deals. In this example, of course, Customers can search by currency pair and Provider. The system, may be configured, however, to search based on other transaction details. Upon hitting the Set Filter 408 button, the screen will reload and Table 410 (located below Filter Parameter Area 402) will only show deals that fit the specified filter criteria.

In preferred embodiments, the behavior of the currency pair filter depends on the placement of the “period” in the value entered. For example:

| Value Entered | Result |
|---|---|
| CCY. | Searches for deals with base currency of CCY |
| .CCY | Searches for deals with terms currency of CCY |
| CCY | Searches for deals with either base or terms currency |
| | CCY |
| CCY1.CCY1 | Searches for deals with base currency CCY1 and terms |
| | currency CCY2 |

The second section of the Working Blotter screen is a Table 410 of active deals. This table is shown in FIG. 4., Table 410 displays the status of each deal. Toward the right end of the Table, the Actions Column 412, contains hyperlinks that can be clicked to lock a deal. However, the View buttons in the action column will display deals without locking them. Thus, deals locked by one user can still be viewed by others.

As shown in FIG. 4, Table 410 contains numerous links and boxes to help the user perform specific tasks and see more specific information about the deals in the table. For example, the following buttons and functions are provided in a preferred embodiment:

View—Shows a read-only ticket containing the selected deal

PTA—Locks the deal and starts a Post Trade Allocation amendment

VDTF—Locks the deal and starts a Value Date to Follow amendment

Resume PTA—Resumes a Post Trade Allocation amendment

Resume VDTF—Resumes a Value Date to Follow amendment

Resume CAR—Resumes a Cancel and Rebook amendment

Resume HRR—Resumes a Historical Rate Rollover amendment

Resume RAR—Resumes a Rebook at Average Rate amendment

Submit—Submits the pre-prepared ticket to the provider

Rebook at Average Rate—Combines multiple deals into a single deal.

The information in the Working Blotter's Table 410 can be sorted by clicking on any of the column headers that are underlined. In embodiments, an arrow icon appears next to column headers that the table is sorted by. An up arrow will represent the column sorted in ascending order; likewise, a down arrow will represent the column sorted in descending order.

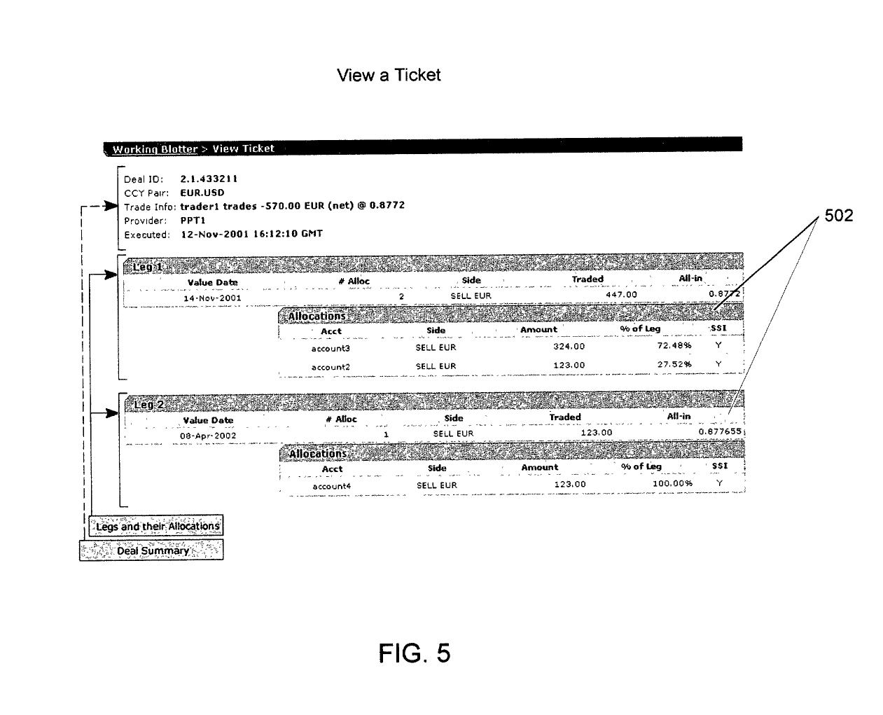

To expand and view a deal ticket from the Working Blotter, the Customer clicks on the View hyperlink in the row of the deal that he or she want to see. FIG. 5 shows an example of a deal ticket so expanded.

Preferably, Amendment Tool Server 126 component of the invention is configured to update the screen on the Working Blotter in real time (thereby providing up-to-the-minute status information concerning pending and negotiating deals). This may be accomplished, even though firewalls and proxies, through the use of server push technology, as is known in the art, which provides a way for servers to send unsolicited messages to browser clients. Random Walk, Inc., of New York, N.Y., for example, offers a product, known as the JTIWEB Framework, that may suitably adapted and implemented for these purposes in embodiments of the present invention. The customer may also update the Working Blotter screen manually by hitting the refresh button in his browser.

3. Archive Blotter

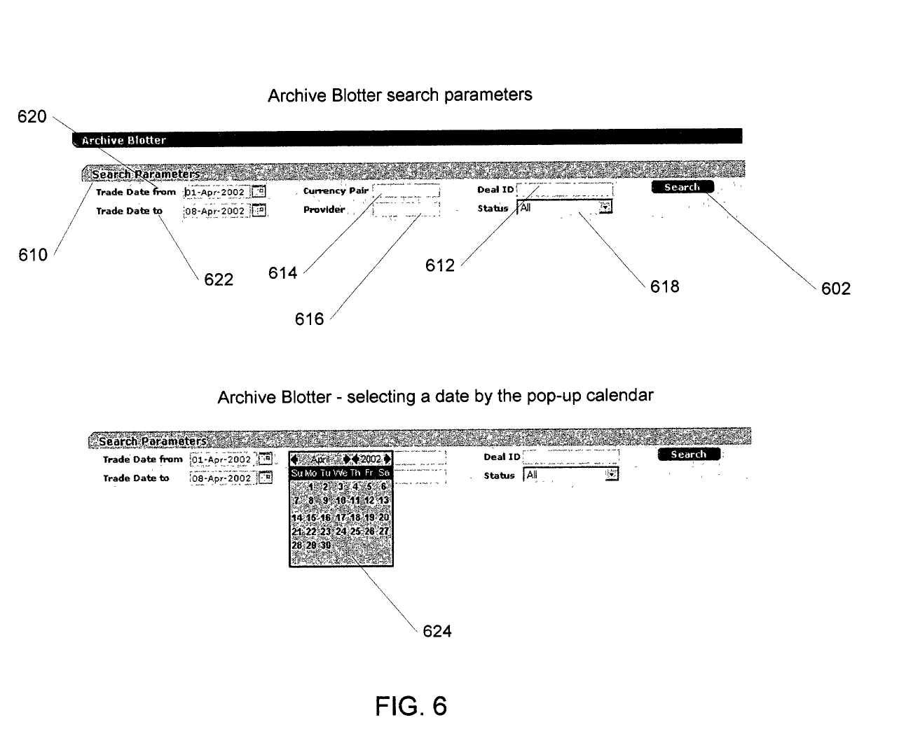

The Archive Blotter (shown in FIG. 6) provides the ability to search for completed deals by specifying search criteria. In embodiments, Customers can perform the following actions from the Archive Blotter:

Search for Deals

Export Deals

View a Ticket

Initiate a Cancel and Rebook Amendment

Initiate a Historical Rate Rollover Amendment

Search

The upper portion of the Archive Blotter, section 610, comprises the search parameters area. This section contains a plurality of fields a Customer can can use to perform a search. For example, the Customer may search within a particular date range by providing dates in the trade date to and trade date from fields in section 610. The Customer could also decide to search for deals by Deal ID 612, currency pair 614, provider 616 or status 618.

Trade Date to field 620 and Trade Date From field 622 each have a calendar icon beside them, which, when selected, displays Interactive Calendar 624. Customers can navigate and select the desired date from Interactive Calendar 624 by clicking the left and right arrows on top of the calendar. The calendar will disappear and fill in the date field with upon making a date selection.

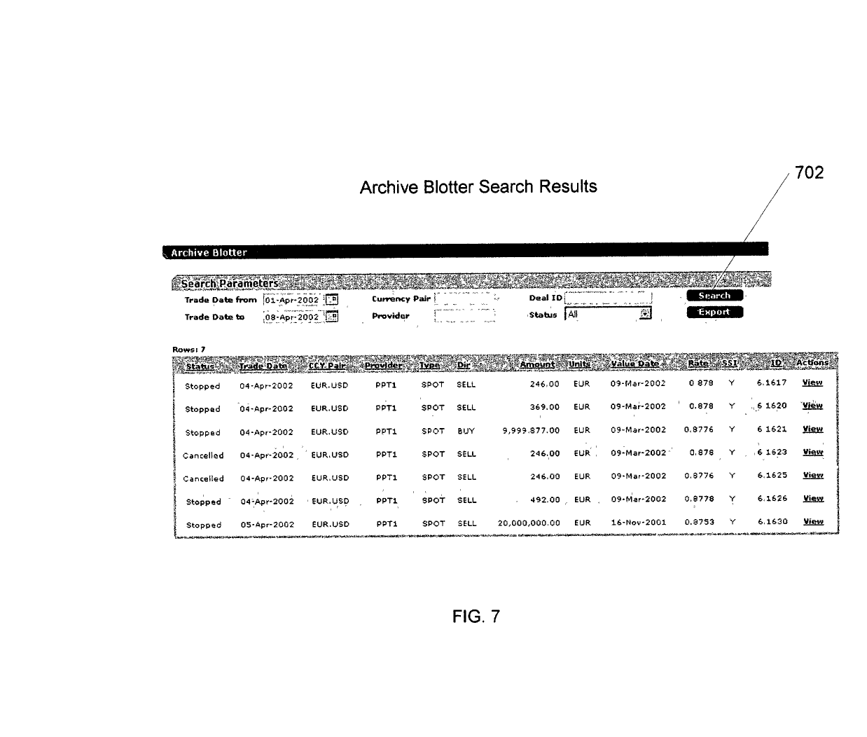

After filling in any of the desired fields, Customers can initiate a search by clicking on the Search button. The results will appear in a table (like the table shown in FIG. 4), which will be located below the search parameter area 610. An example of the Archive Blotter search results is shown in FIG. 7.

4. Exporting Archive Blotter Search Results

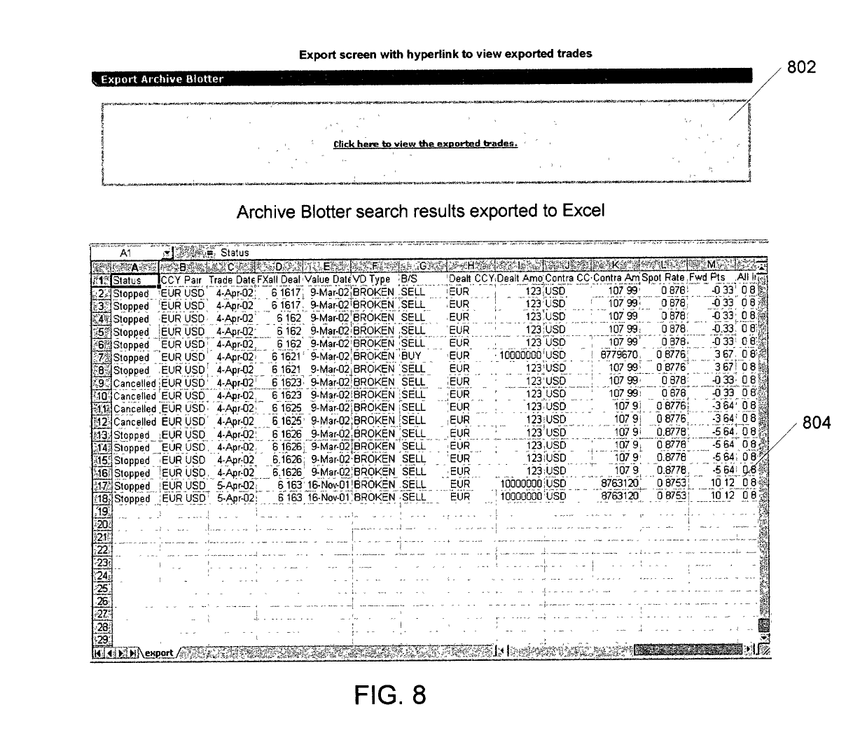

Customers may export Archive Blotter Search results by clicking on Export Button 702 of FIG. 7. The Export button 702 is visible whenever search results are shown to the Customer. In preferred embodiments, another browser window (designated 802 in FIG. 8) opens immediately with a hyperlink to view the exported trades (see 804 in FIG. 8). Amendment Tool Interface 118 may also be configured to display the exported search results in Microsoft Excel® or another program capable of reading the comma-separated variables file format.

5. Post Trade Allocation Amendment Process

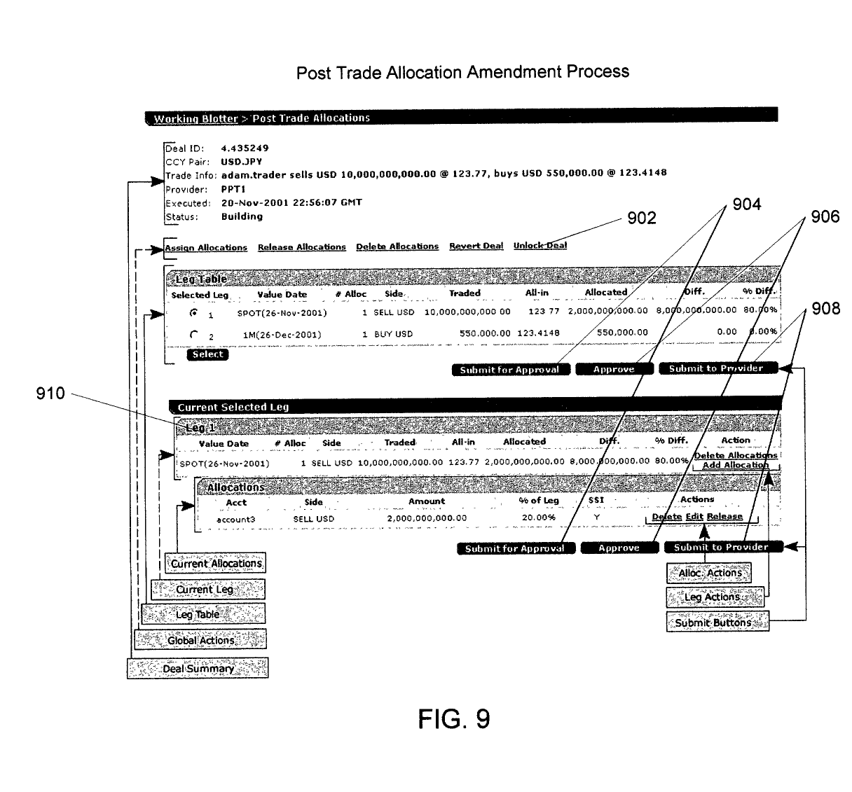

Post Trade Allocation (PTA) amendments may be initiated from the Working Blotter by clicking on one of the PTA link's in Actions Column 412 of Table 410. FIG. 9 depicts an example of a PTA amendment ticket. If the PTA amendment process has already been initiated, then the Customer may click on a “Resume PTA” link instead. At after initiating the PTA process by clicking on one of these buttons, the Customer may aAssign allocations or add, edit, delete, and release allocations by clicking on the appropriate hyperlinks shown in Global Actions Area 902 of FIG. 9.

At any point during the amendment construction, the Customer may unlock or revert a deal. Unlocking the deal returns theCustomer to the working blotter and allows another user to complete the amendment. Reverting the deal erases any changes made during amendment preparation and returns the deal to its original state.

Once the desired modifications to the deal are complete, the Customer may click the Submit for Approval 904, Approve 906, or Submit to Provider 908 buttons to have the proposed amendment submitted for processing, stored so that the Customer can continue building it later, or submitted to a Provider. For convenience, these buttons are located both above and below the current selected leg table 910. If the Customer submits the deal for approval, the status will then be determined and the Customer will be allowed to either click on the Resume Building, Approve, or Submit to Provider buttons. If the Customer selects “Approve,” the status will change to “ready” and the Customer may resume building the amendment or submit it to a Provider. If the Customer submits the deal, the status will change to “submitted,” at which point the Customer may stop negotiations and wait until the provider has approved or rejected the amendment.

If the provider accepts the deal, the status changes to “ready.” At this point the Customer can choose to resume building and edit the amendment. If the deal is rejected, there will be an error message on the ticket. If a Customer has chosen to stop the negotiation, the status of the deal changes to “ready” and the Customer can resume building and/or editing so he can re-submit the deal. Messages from the Provider, including error messages are shown below the deal summary.

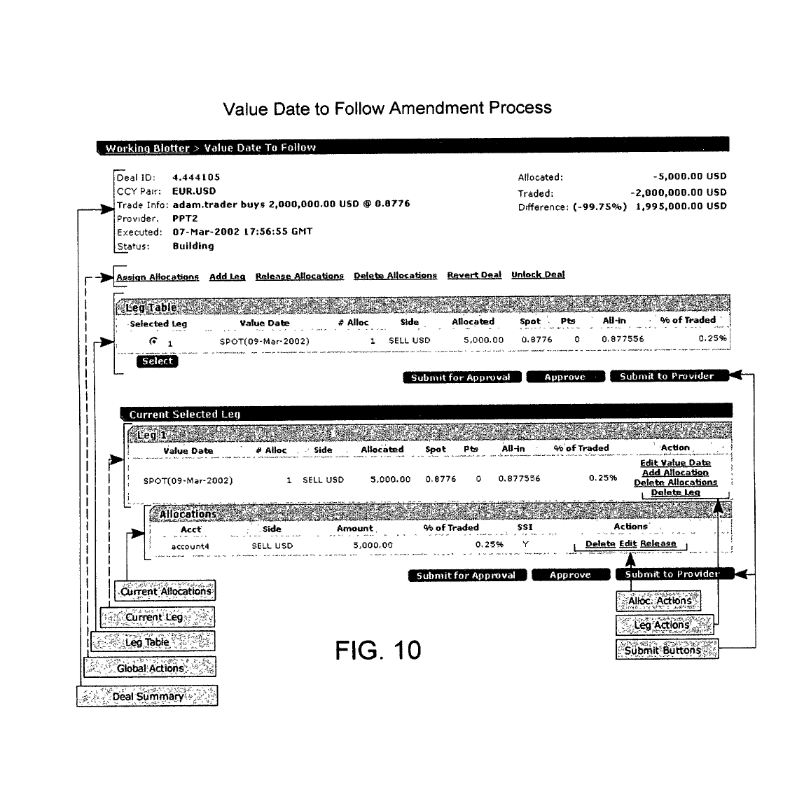

A Value Date to Follow (VDTF) amendment may be initiated from the Working Blotter screen by clicking on one of the VDTF hyperlinks in the Actions Column 412 of FIG. 4. An example of a VDTF amendment ticket is provided in FIG. 10. If the VDTF amendment process has already been initiated, then the Customer may click on the Resume VDTF hyperlink instead. At that point, the Customer can make all the desired changes to the amendment ticket. For example, the customer may add and delete legs, edit a leg's value date, assign allocations, and add, edit, delete and release desired allocations by clicking on appropriate hyperlinks. At any point during the amendment construction you can unlock or revert the deal. Unlocking the deal returns you to the working blotter and allows another user to complete the amendment. Reverting the deal erases any changes made during amendment preparation and returns the deal to its original state. After the desired modifications to the deal are complete, the Customer clicks the Submit for Approval, Approve, or Submit to Provider buttons, which operate the same as they did in the PTA amendment context, except that the Customer now waits for a quote, as opposed to an acceptance or rejection:.

When the Provider returns a quote (which will be displayed in ‘Pts’ and ‘All-in’ fields of each leg in the ticket display of FIG. 10), the Customer may request a re-quote for a more competitive rate, accept provider's quote, or stop the negotiation. To request a more competitive rate, the Customer clicks on the Re-quote button and the status changes to “quote rejected.”

To accept the quote, the Customer clicks on the Accept button. The status of the deal will be changed to “pending.” If the Customer has break accounts in her allocation, then the status will eventually change to “waiting,” otherwise it will be changed to “completed”. If an problem occurs, including a change in the Provider's price which occurred during this process, the status will change to “failed.”

6. Cancel and Rebook Amendment Process

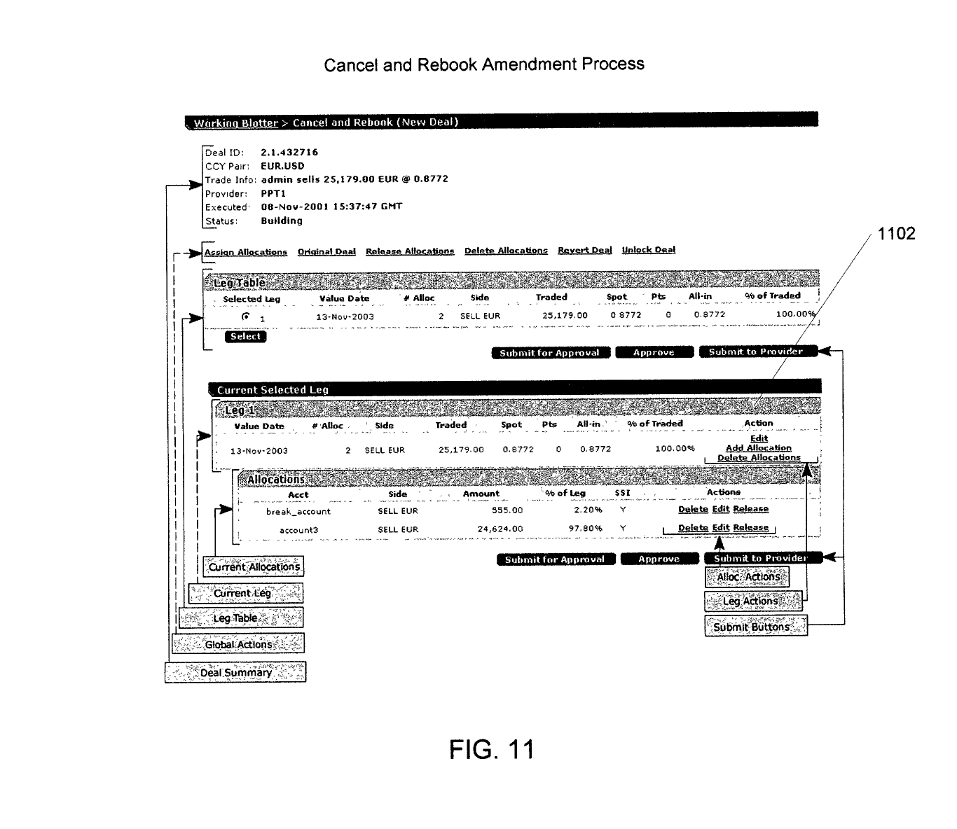

A cancel and rebook (CAR) amendment may be initiated from the Archive Blotter screen by clicking on one of the CAR hyperlinks in the Archive Blotter search results table. An example of a CAR amendment ticket is shown in FIG. 11. If the CAR amendment process has already been initiated, a CAR amendment may be initiated by clicking on the Resume CAR link from the Working Blotter, since it is now an active deal. At any point before the amendment is submitted, Customers can click on the Original Deal hyperlink as a toggle to see the original deal. Likewise, when viewing the original deal, the New Deal hyperlink will return you to the CAR ticket that you are amending. At any point during the amendment construction, the Customer can also unlock or revert the deal, which returns the Customer to the Working Blotter and allows another user to complete the amendment. Reverting the deal erases any changes made during amendment preparation and returns the deal to its original state.

Once the desired modifications to the deal are complete, the Customer may Submit for Approval, Approve, or Submit to Provider buttons. When the provider sends a quote (which will be displayed in the ‘Spot, ‘Pts’, and ‘All-In’ field of the current leg table 1102 of FIG. 11), the Customer may request a re-quote for a more competitive rate, accept Provider's quote, accept Provider's Cancel Request or stop the negotiation.

To request a more competitive rate, the Customer simply clicks on the “Re-quote” button and the status changes quote rejected. Once a Customer has requested a re-quote, no other re-quotes are permitted until the original provider has sent another quote. Thus, the re-quote button is only visible while the status of the amendment is quoting.

To accept the quote, the Customer clicks on the Accept button. The status will change to “pending.” If the customer has break accounts in his allocation, then the status will eventually change to “waiting” or “completed.” If an error occurs, including the bank's price changing during this process, the status will change to failed.

Notably, the Provider can request to cancel the deal. If the Provider does this, a message will be sent to the Customer that says, “Provider requested to cancel the deal” and the status will change to “submitted” (cancel requested). At this point Customer may click on the Accept Cancel, Reject Cancel (which indicates that the cancel request has not been accepted) or Stop the Negotiation buttons.

7. Historical Rate Rollover Amendment Process

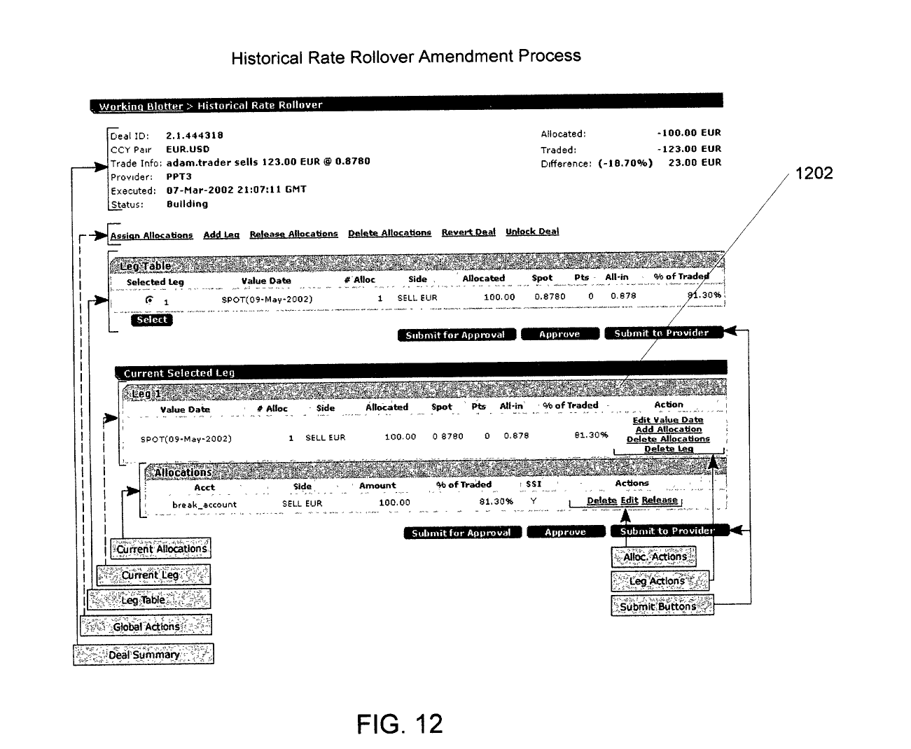

An HRR amendment may be initiatiated from the Archive Blotter screen by clicking on one of the HRR links in the row of the deal that you would like to amend. FIG. 12 provides an example of a deal amendment ticket for an HRR. Again, the Customer builds and/or submits the deal to the Provider. When the provider sends a quote (which will be displayed in ‘Pts’ and ‘All-in’ field of each leg table 1202 of FIG. 12), you may request a re-quote for a more competitive rate, accept provider's quote, or stop the negotiation. To request a more competitive rate, the Customer may click Re-quote button, whereupon the status of the deal changes to “quote rejected.” At this point the Customer will have the same options as before.

8. Rebook at Average Rate Amendment Process

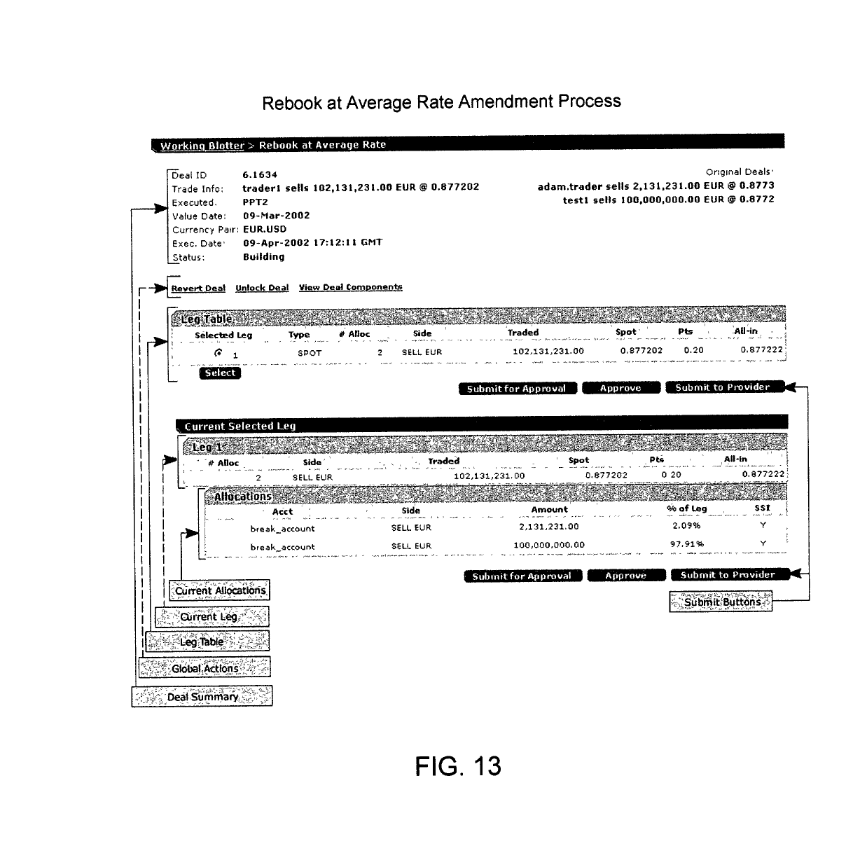

FIG. 13 displays an example of a user interface screen that could be used to implement a system in accordance with the present invention to rebook a transaction at an average rate. A rebook at average rate (RAR) amendment may be initiated from the Working Blotter by selecting multiple compatible deals (two or more) by checking their corresponding check boxes in the rightmost column and selecting the “Rebook Selected at Average Rate” hyperlink, which is located above the Working Blotter table on the right side (see item 414 of FIG. 4) To rebook at an average rate, the deals must have an identical provider, value dates, and currency pair. Further, the deals must have only one leg.

9. Importing Allocations

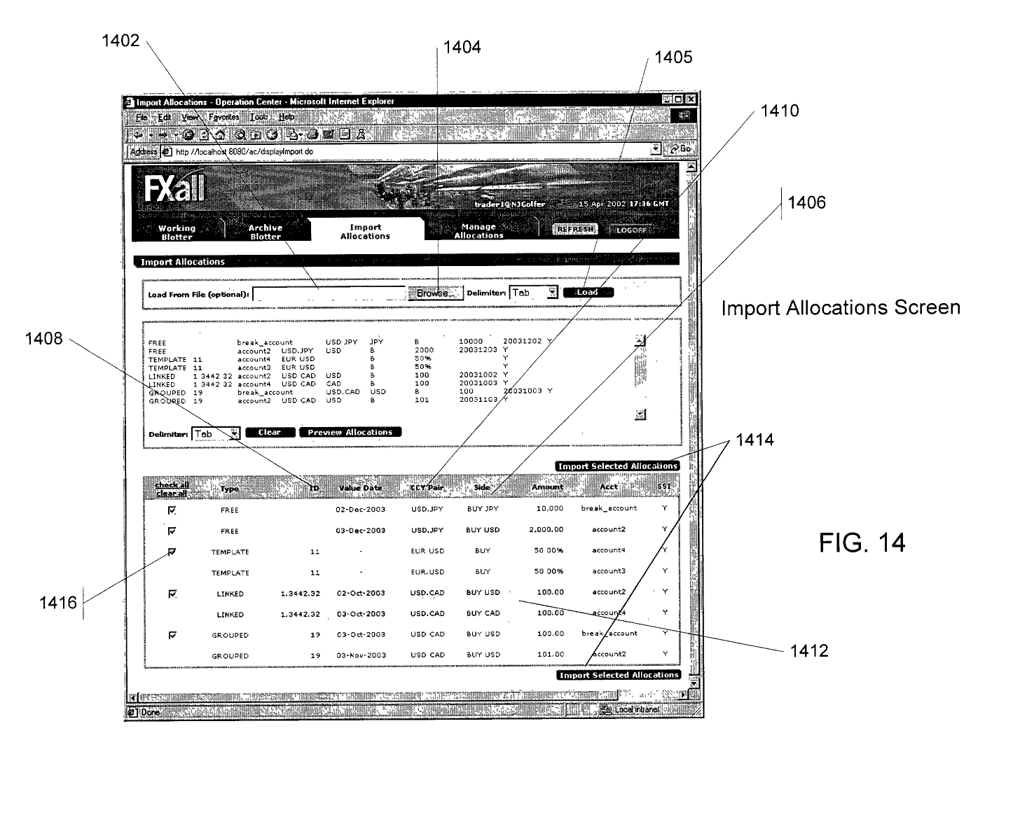

FIG. 14 depicts an exemplary user interface screen for the Import Allocations Window, which provides a way to import allocations in bulk based on text from a file or data pasted from the clipboard. To load allocations from a file, the Customer types a filename in the Load From File Field 1402 or selects the Browse Button 1404 to choose from a list of files displayed in a Choose File Dialog Box (not shown in FIG. 14). Once the Customer selects the file and clicks on the Open Button in the Choose File Dialog Box, Input Field 1402 shows the path to the desired file.

Customers can preview outcome of importing the selected file via the editable Preview Allocations Window 1406 shown at the bottom of FIG. 14 by clicking on Load Button 1405. Typically, although not necessarily, the allocations in the selected file are restricted to certain format (delimited by commas or tabs), such as: Allocation type, ID, account, currency pair, units, side, amount, value date, and SSI. In some contexts, such as when importing free allocations (described below), the ID Field 1408 may not be used and therefore may be left blank. The Currency Pair Field 1410 may be optional and the Value Date Field may need to be left blank for some situations, such as when importing template allocations (also described below).

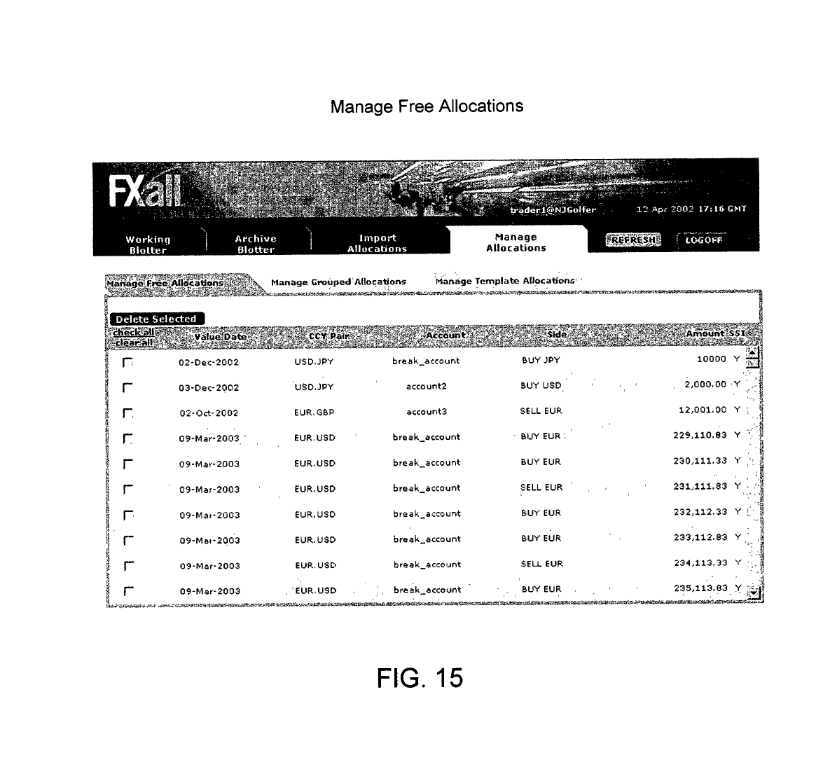

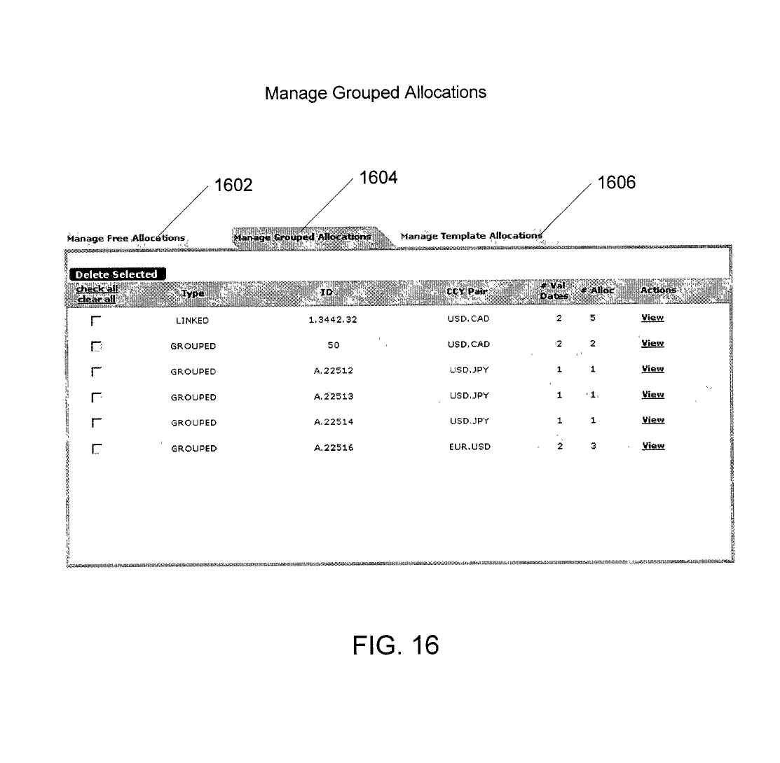

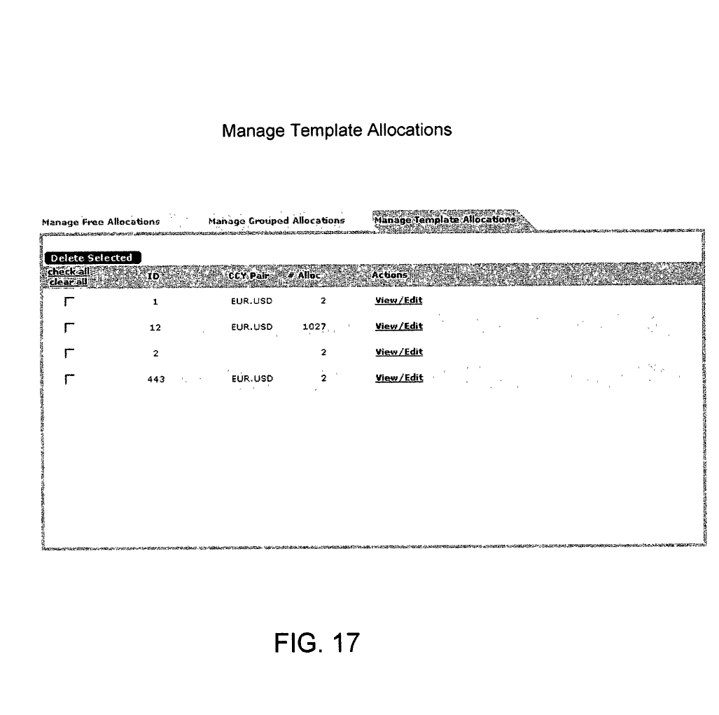

Customers typically mark which allocations to import via Checkbox Column 1416 invoke processing of those allocations by clicking on one of the two Import Selected Allocations Buttons 1414, which are displayed above and below Preview Allocations Window 1406. Free allocations are added to the Manage Free Allocations Blotter (shown in FIG. 15), while linked or grouped allocations are added to the Manage Grouped Allocations Blotter (FIG. 16). Template allocations are added to the Manage Template Allocations blotter (FIG. 17). Another way to import allocations is to directly type or paste in text from the clipboard.

10. Managing Allocations

Clicking on the Manage Allocations Tab in any interface screen in Amendment Tool Interface 118 will display one of several user interface screens configured to facilitate managing allocations (as shown in FIG. 15). Customers may toggle between the Manage Free Allocations Blotter, Manage Grouped Allocations Blotter, and the Manage Template Allocations Blotter by selecting one of the tabs 1602, 1604 and 1606. Manage Free Allocations Blotter (FIG. 15) is the default selection.

Free allocations are allocations that have not yet been grouped into currency pairs or associated with any particular deals. Grouped allocations are allocations that are grouped by currency pairs, but are not yet attached to a deal. Template allocations are similar to grouped allocations, except that template allocations may be reused for multiple deals. Through the Manage Allocations tab, Customers may view, change or delete free, grouped and template allocations, assign them to deals, etc.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims. Therefore, for example, it should be understood by one skilled in the art that the present invention is not limited to foreign exchange transactions, and may be beneficially applied to other types of transactions as described above.

What is claimed is:

1. A computer-implemented method for conducting a transaction comprising:
receiving from a customer an amendment for the transaction;
sending the amendment to the provider;
receiving from the provider a confirmation for the transaction, the transaction including the amendment, and
sending the confirmation to the customer.

2. The method of claim 1, wherein the amendment comprises a list of accounts to be used for executing the transaction.

3. The method of claim 2, wherein the transaction involves a block of value units; and the amendment comprises an instruction to allocate a subset of the block of value units to an account in the list of accounts.

4. The method of claim 3, wherein the number of value units in the subset is equal to the number of value units in the block of value units.

5. The method of claim 2, wherein the list of accounts includes only one account.

6. The method of claim 1, wherein the amendment comprises a proposed value date for the transaction.

7. The method of claim 1, wherein the amendment comprises an identification of a second transaction to be combined with the transaction to form a consolidated transaction.

8. The method of claim 7, wherein the amendment further comprises a request to book the consolidated transaction at an average rate.

9. The method claim 8, wherein the average rate comprises a weighted average rate calculated by the provider.

10. The method of claim 1, further comprising receiving, prior to receiving the amendment, an indication from the customer that the amendment will follow.

11. The method of claim 10, wherein the indication comprises the use of a designated account.

12. The method of claim 1, wherein the transaction is a currency exchange transaction.

13. The method of claim 1, further comprising the step of receiving a transaction term from the provider responsive to the amendment.

14. The method of claim 13, further comprising an offer to deal from the customer responsive to the transaction term.

15. The method of claim 1, wherein the amendment comprises a request to cancel the transaction.

16. The method of claim 1, wherein the amendment comprises a request to rebook the transaction.

17. The method of claim 1, wherein the amendment comprises a request to change a transaction amount.

18. The method of claim 1, wherein the amendment comprises a request to change an allocation of transaction funds.

19. The method of claim 1, wherein the amendment comprises a request to change a value date.

20. The method of claim 1, wherein the amendment comprises a request to change an execution rate.

21. The method of claim 1, wherein the amendment comprises a request to use an execution rate associated with a previous transaction.

22. The method of claim 1 or 21, wherein the amendment comprises a request to apply a historical rate rollover to the transaction.

23. The method claim 21, wherein the transaction is scheduled to mature at a date later than the previous transaction.

24. The method of claim 1, further comprising the step of sending the transaction to the provider.

25. A computer-implemented method for conducting a transaction comprising:
during a first phase of operation,
establishing a first communications channel with a provider,
sending, via the first communications channel, an indication that an amendment to the transaction will be provided during a second phase of operation; and
during the second phase of operation,
establishing a second communications channel with the provider,
sending the amendment to the provider via the second communications channel, and
receiving from the provider, via the second communications channel, a confirmation for a revised transaction, the revised transaction including the amendment.

26. The method of claim 25, wherein the amendment comprises a list of accounts to be used for executing the transaction.

27. The method of claim 26, wherein the transaction involves a block of value units; and the amendment comprises an instruction to allocate a subset of the block of value units to an account in the list of accounts.

28. The method of claim 27, wherein the number of value units in the subset is equal to the number of value units in the block of value units.

29. The method of claim 26, wherein the list of accounts includes only one account.

30. The method of claim 25, wherein the amendment comprises a proposed value date for the transaction.

31. The method of claim 25, wherein the amendment comprises an identification of a second transaction to be combined with the transaction to form the revised transaction.

32. The method of claim 31, wherein the amendment further comprises a request to book the revised transaction at an average rate.

33. The method claim 32, wherein the average rate comprises a weighted average rate calculated by the provider.

34. The method of claim 25, wherein the indication comprises the use of a designated account.

35. The method of claim 25, wherein the transaction is a currency exchange transaction.

36. The method of claim 25, wherein the first phase of operation and the second phase of operation occur on different dates.

37. The method of claim 25, wherein the first phase of operation occurs before the second phase of operation.

38. The method of claim 25, wherein the first phase of operation and the second phase of operation occur substantially simultaneously.

39. The method of claim 38, wherein the first communications channel and the second communications channel are the same.

40. The method of claim 25, wherein the first data communications channel comprises a voice transmission over a public telephone network.

41. The method of claim 25, wherein the first data communications channel comprises a facsimile transmission.

42. The method of claim 25, further comprising the step of receiving from the provider a transaction term responsive to the amendment.

43. The method of claim 42, further comprising sending to the provider an offer to deal responsive to the transaction term.

44. The method of claim 42, further comprising receiving from the provider a deal completion signal responsive to the offer to deal.

45. The method of claim 25, wherein the amendment comprises a request to cancel the transaction.

46. The method of claim 25, wherein the amendment comprises a request to rebook the transaction.

47. The method of claim 25, wherein the amendment comprises a request to change a transaction amount.

48. The method of claim 25, wherein the amendment comprises a request to change an allocation of transaction funds.

49. The method of claim 25, wherein the amendment comprises a request to change a value date.

50. The method of claim 25, wherein the amendment comprises a request to change an execution rate.

51. The method of claim 25, wherein the amendment comprises a request to use an execution rate associated with a previous transaction.

52. The method of claim 25 or 51, wherein the amendment comprises a request to apply a historical rate rollover to the transaction.

53. The method claim 51, wherein the transaction is scheduled to mature at a date later than the previous transaction.

54. The method of claim 25, further comprising the step of sending the transaction to the provider via the second communications channel.

55. A computer-implemented method for conducting a transaction comprising:
during a first phase of operation,
establishing a first communications channel with a customer,
receiving from the customer, via the first communications channel, an indication that an amendment to the transaction will be provided during a second phase of operation; and
during the second phase of operation,
establishing a second communications channel with the customer,
receiving the amendment from the customer via the second communications channel,
sending to the customer, via the second communications channel, a confirmation for a revised transaction, the revised transaction including the amendment.

56. The method of claim 55, wherein the amendment comprises a list of accounts to be used for executing the transaction.

57. The method of claim 56, wherein the transaction involves a block of value units; and the amendment comprises an instruction to allocate a subset of the block of value units to an account in the list of accounts.

58. The method of claim 57, wherein the number of value units in the subset is equal to the number of value units in the block of value units.

59. The method of claim 56, wherein the list of accounts includes only one account.

60. The method of claim 55, wherein the amendment comprises a proposed value date for the transaction.

61. The method of claim 55, wherein the amendment comprises an identification of a second transaction to be combined with the transaction to form the revised transaction.

62. The method of claim 61, wherein the amendment further comprises a request to book the revised transaction at an average rate.

63. The method claim 62, further comprising calculating a weighted average.

64. The method of claim 55, wherein the indication comprises the use of a designated account.

65. The method of claim 55, wherein the transaction is a currency exchange transaction.

66. The method of claim 55, wherein the first phase of operation and the second phase of operation occur on different dates.

67. The method of claim 55, wherein the first phase of operation occurs before the second phase of operation.

68. The method of claim 55, wherein the first phase of operation and the second phase of operation occur substantially simultaneously.

69. The method of claim 68, wherein the first communications channel and the second communications channel are the same.

70. The method of claim 55, wherein the amendment comprises a request to cancel the transaction.

71. The method of claim 55, wherein the amendment comprises a request to rebook the transaction.

72. The method of claim 55, wherein the amendment comprises a request to change a transaction amount.

73. The method of claim 55, wherein the amendment comprises a request to change an allocation of transaction funds.

74. The method of claim 55, wherein the amendment comprises a request to change a value date.

75. The method of claim 55, wherein the amendment comprises a request to change an execution rate.

76. The method of claim 55, wherein the amendment comprises a request to use an execution rate associated with a previous transaction.

77. The method of claim 55 or 76, wherein the amendment comprises a request to apply a historical rate rollover to the transaction.

78. The method claim 76, wherein the transaction is scheduled to mature at a date later than the previous transaction.

79. The method of claim 55, further comprising the step of sending the transaction to the provider via the second communications channel.

80. The method of claim 55, wherein the first phase of operation and the second phase of operation occur on different dates.

81. The method of claim 55, wherein the first phase of operation and the second phase of operation occur substantially simultaneously.

82. The method of claim 81, where the first communications channel and the second communications channel are the same.

83. The method of claim 55, further comprising:
receiving from the customer, via the second communications channel, an offer to deal responsive to the confirmation.

84. The method of claim 83, further comprising:
sending to the customer, via the second communications channel, a deal completion signal responsive to the offer to deal.

85. The method of claim 84, wherein the deal completion signal comprises an approval of the revised transaction.

86. The method of claim 84, wherein the deal completion signal comprises a rejection of the revised transaction.

87. A computerized method for conducting a transaction, comprising:
during a first phase of operation,
displaying a user activated control configured to indicate whether an amendment for the transaction will be provided in a second phase of operation, the control being responsive to an input by a customer, and
updating a status field of a transaction database in response to a value of the control; and
during the second phase of operation,
displaying, in response to the status field of the transaction database, a graphical representation of an amendment ticket, the amendment ticket being configured to accept the amendment from the customer,
sending a summary of a revised transaction to a provider, the revised transaction including the amendment,
receiving an input from the provider in response to the summary, and
updating the status field in the transaction database in response to the input.

88. The method of claim 87, wherein the input comprises an approval of the revised transaction by the provider.

89. The method of claim 87, wherein the input comprises a rejection of the revised transaction by the provider.

90. The method of claim 87, wherein the first phase and the second phase occur substantially simultaneously.

91. A computer-readable storage medium encoded with a computer-executable program for conducting a transaction, the program comprising:
code configured to execute during a first phase of operation,
to display a graphical representation of a trading ticket for the transaction, the trading ticket including a price quote from a provider,
to display a user-activated first control configured to indicate whether a customer has accepted the price quote,
to display a user-activated second control configured to indicate whether an amendment for the transaction will be provided in a second phase of operation, and
responsive to an activation of the first control by the customer,
to send a notification to a provider indicating that the price quote was accepted, and
to update a status field of a transaction database in response to the value of the second control; and
code configured to execute during the second phase of operation,
to display, in response to the status field of the transaction database, a graphical representation of an amendment ticket, the amendment ticket being configured to accept the amendment from the customer,
to send a summary of a revised transaction to the provider, the summary including the amendment,
to receive an input from the provider in response to the summary, and
to update the status field in the transaction database in response to the input.

92. The computer-readable storage medium of claim 91, wherein the input comprises an approval of the revised transaction by the provider.

93. The computer-readable storage medium of claim 91, wherein the input comprises a rejection of the revised transaction by the provider.

94. The computer-readable storage medium of claim 91, wherein the input comprises a transaction term; and the code configured to execute during the second phase of operation is further configured
to receive from the customer an offer to deal responsive to the transaction term,
to receive from the provider a deal completion signal responsive to the offer to deal, and
to update the status field in the transaction database responsive to the deal completion signal.

95. The computer-readable storage medium of claim 91, wherein the deal completion signal comprises an approval.

96. The computer-readable storage medium of claim 91, wherein the deal completion signal comprises a rejection.

97. The computer-readable storage medium of claim 91, wherein the first phase of operation and the second phase of operation occur substantially simultaneously.

98. A computer system for conducting a transaction comprising:
a customer client program configured
to display to a customer, responsive to the operation of a server program, a transaction, and
to accept from the customer an amended transaction based on the transaction; and
a provider client program configured
to display to a provider, responsive to the operation of the server program, the amended transaction, and
to accept an input from the provider responsive to the amended transaction;
wherein the server program is configured to convey the amended transaction from the customer client program to the provider client program, and to convey the input from the provider client program to the customer client program.

99. The computer system of claim 98, wherein the amended transaction comprises a request to cancel the transaction.

100. The computer system of claim 98, wherein the amended transaction comprises a request to rebook the transaction.

101. The computer system of claim 98, wherein the amended transaction comprises a request to change a transaction amount.

102. The computer system of claim 98, wherein the amended transaction comprises a request to change an allocation of transaction funds.

103. The computer system of claim 98, wherein the amended transaction comprises a request to change a value date.

104. The computer system of claim 98, wherein the amended transaction comprises a request to change an execution rate.

105. The computer system of claim 98, wherein the amended transaction comprises a request to use an execution rate associated with a previous transaction.

106. The computer system of claim 98 or 105, wherein the amended transaction comprises a request to apply a historical rate rollover to the transaction.

107. The computer system of claim 105, wherein the transaction is scheduled to mature at a date later than the previous transaction.

108. The computer system of claim 98, further comprising a database configured to maintain an amendment status for the transaction.

109. The computer system of claim 108, wherein the server program is further configured to modify the amendment status responsive to the receipt of the amended transaction from the customer client program.

110. The computer system of claim 108, wherein the server program is further configured to modify the amendment status responsive to the receipt of the input from the provider client program.

111. The computer system of claim 98, 108, 109 or 110, wherein the input comprises an approval of the amended transaction by the provider.

112. The computer system of claim 98, 108, 109 or 110, wherein the input comprises a rejection of the amended transaction by the provider.

113. The computer system of claim 98, wherein
the input comprises a transaction term responsive to the amended transaction; and
the server program is further configured to accept from the customer client program an offer to deal responsive to the transaction term, and to accept from the provider client program a deal completion signal responsive to the offer to deal.

114. The computer system of claim 113, wherein the deal completion signal comprises an approval of the amended transaction.

115. The computer system of claim 113, wherein the deal completion signal comprises a rejection of the amended transaction.

116. A computer-implemented method for conducting a currency exchange transaction, comprising:
sending an offer to deal for the currency exchange transaction;
receiving a confirmation that the offer to deal was approved;
sending an amendment to the currency exchange transaction; and
receiving a confirmation that the amendment was approved.

117. The method of claim 116, wherein the amendment comprises a request to cancel the currency exchange transaction.

118. The method of claim 116, wherein the amendment comprises a request to rebook the currency exchange transaction.

119. The method of claim 116, wherein the amendment comprises a request to change a transaction amount.

120. The method of claim 116, wherein the amendment comprises a request to change an allocation of transaction funds.

121. The method of claim 116, wherein the amendment comprises a request to change a value date.

122. The method of claim 116, wherein the amendment comprises a request to change an execution rate.

123. The method of claim 116, wherein the amendment comprises a request to use an execution rate associated with a previous currency exchange transaction.

124. The method of claim 116 or 123, wherein the amendment comprises a request to apply a historical rate rollover to the currency exchange transaction.

125. The method of claim 133, wherein the currency exchange transaction is scheduled to mature at a date later than the previous transaction.

126. The method of claim 116, further comprising updating a database configured to maintain an amendment status for the currency exchange transaction.

127. A computer-implemented method for conducting a currency exchange transaction, comprising:
receiving an offer to deal for the currency exchange transaction;
sending a confirmation that the offer to deal was approved;
receiving an amendment to the currency exchange transaction; and
sending a confirmation that the amendment was approved.

128. The method of claim 127, wherein the amendment comprises a request to cancel the currency exchange transaction.

129. The method of claim 127, wherein the amendment comprises a request to rebook the currency exchange transaction.

130. The method of claim 127, wherein the amendment comprises a request to change a transaction amount.

131. The method of claim 127, wherein the amendment comprises a request to change an allocation of transaction funds.

132. The method of claim 127, wherein the amendment comprises a request to change a value date.

133. The method of claim 127, wherein the amendment comprises a request to change an execution rate.

134. The method of claim 127, wherein the amendment comprises a request to use an execution rate associated with a previous currency exchange transaction.

135. The method of claim 127 or 134, wherein the amendment comprises a request to apply a historical rate rollover to the currency exchange transaction.

136. The method of claim 134, wherein the currency exchange transaction is scheduled to mature at a date later than the previous currency exchange transaction.

137. The method of claim 127, further comprising updating a database configured to maintain an amendment status for the currency exchange transaction.

138. A computerized method for conducting a transaction, comprising:
displaying, in response to a status field of a transaction database, a graphical representation of an amendment ticket, the amendment ticket being configured to accept from a customer an amendment for the transaction;
sending a summary of a revised transaction to a provider, the revised transaction including the amendment;
receiving an input from the provider in response to the summary; and
updating the status field in the transaction database in response to the input.

139. The method of claim 138, wherein the input comprises an approval of the revised transaction by the provider.

140. The method of claim 138, wherein the input comprises a rejection of the revised transaction by the provider.

141. The method of claim 138, wherein the input comprises a transaction term responsive to the revised transaction.

142. The method of claim 141, further comprising:
receiving an offer to deal responsive to the transaction term; and
receiving a deal completion signal responsive to the offer to deal.

143. The method of claim 142, wherein the deal completion signal comprises an approval of the revised transaction.

144. The method of claim 142, wherein the deal completion signal comprises a rejection of the revised transaction.

145. A computer-readable storage medium encoded with a computer-executable program for conducting a transaction, the program comprising:
code configured to display, in response to a status field of a transaction database, a graphical representation of an amendment ticket, the amendment ticket being configured to accept from a customer an amendment to the transaction;
code configured to send a summary of a revised transaction to a provider, the revised transaction including the amendment;
code configured to receive an input from the provider in response to the summary, and to update the status field in the transaction database in response to the input.

146. The computer-readable storage medium of claim 145, wherein the input comprises an approval of the revised transaction by the provider.

147. The computer-readable storage medium of claim 145, wherein the input comprises a rejection of the revised transaction by the provider.

148. The computer-readable storage medium of claim 145, wherein:
the input comprises a transaction term; and
the code configured to execute during the second phase of operation is further configured
to receive from the customer an offer to deal responsive to the transaction term,
to receive from the provider a deal completion signal responsive to the offer to deal, and
to update the status field in the transaction database responsive to the deal completion signal.

149. The computer-readable storage medium of claim 148, wherein the deal completion signal comprises an approval of the revised transaction.

150. The computer-readable storage medium of claim 148, wherein the deal completion signal comprises a rejection of the revised transaction.
